(19) United States
(12) Patent Application Publication
(10) Pub. No.: US 2007/0174390 A1
(43) Pub. Date: Jul. 26, 2007

(54) Customer service management

(75) Inventors: Francois Silvain, Winchester, MA (US); Herve Pluche, Oakland, CA (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Avise Partners, San Francisco, CA (US)

(21) Appl. No.: 11/655,852

(22) Filed: Jan. 22, 2007

Related U.S. Application Data
(60) Provisional application No. 60/760,370, filed on Jan. 20, 2006.
(60) Provisional application No. 60/796,858, filed on May 3, 2006.

(51) Int. Cl. G06F 15/173; G06F 15/16

(52) U.S. Cl. 709/204

(57) ABSTRACT

A customer service management (“CSM”) system that is configurable through graphical user interfaces to incorporate an array of contextual information, including customer context, qualifications of products/services for which support is provided, service context information, knowledge context, tools context, and reporting context. The contextual information is mapped to rules for routing and for information access in order to improve efficiencies. The CSM system provides an ability to customize user forms for look and feel, qualifications, contextual information, tools and resources; geo-localization features, such as case transfer based on the geographical location of a customer or CSM field agent; an ability to integrate with other CSM systems and/or to integrate with CRM systems; a knowledge base and associated tools to manage, publish, and utilize the knowledge base for case resolution; and Web service support and associated integration capabilities based on SML industry standards. The CSM system is also configurable for different levels of integration with customers and partners. The CSM system is based on pre-encoded rules and instructions that are configured through graphical user interfaces.

### CROSS REFERENCE TO RELATED APPLICATIONS

This application claims the benefit of U.S. Provisional Application No. 60/760,370, filed Jan. 20, 2006, titled, “Client Relationship Management,” and U.S. Provisional Application No. 60/796,858, filed May 3, 2006, titled, “Customer Service Management,” both of which are incorporated herein by reference in its entirety.

### BACKGROUND OF THE INVENTION

1. Field of the Invention

The present invention relates to customer service management (“CSM”).

2. Background

Conventional customer service management (“CSM”) computer programs have inherent design limitations and limited capabilities.

Conventional CSM systems are not designed to simultaneously support the constraints of quantity, quality, productivity and collaboration.

Conventional CSM systems are not designed to support thousands of CSM agents in a distributed environment that manage hundreds of thousands of service requests per month and store millions of service requests as history.

Conventional CSM systems are not designed to define a services chart by category (e.g., sales, marketing, technical, etc.) and by level (e.g., technical level 1, 2 or 3) so as to segment service activity according to how a customer wants to be serviced including resolution delay and service quality level.

Conventional CSM systems are not designed to support multiple Service Level Agreements (“SLAs”) that group multiple service activities so as to personalize service by customer and align call center capacities with customer expectations.

Conventional CSM system are not designed to maximize call center productivity and to guarantee the lowest cost per call resolution by providing the ability to customize user forms or graphical user interfaces (GUIs) for look and feel, contextual information, tools, and resources, and to vary these features for different customers and/or agents.

Conventional CSM systems do not provide knowledge bases and associated tools to manage, publish, and utilize these knowledge bases for case resolution.

Conventional CSM systems do not provide for integrated collaborative efforts between different agents and/or partners. More particularly, conventional CSM systems do not allow a case to be divided into associated sub-tasks or child cases, which can be routed to different agents or partners, and where, upon resolution of the child cases, the parent case is automatically closed. Nor do conventional CSM systems allow for the creation of a parent case for (child) cases having similar qualifications, where upon resolution of the parent case, the child cases are automatically resolved

Conventional CSM systems do not provide geo-localization features, such as case transfer capabilities based on the geographical location of a customer or CSM field agent.

Conventional CSM systems do not provide the ability to integrate multiple CSM systems, or to integrate a CSM system with customer relationship management (CRM) systems.

Conventional CSM systems do not provide web service support and associated integration capabilities based on SML industry standards.

Conventional CSM systems are typically custom encoded for each CSM provider. Conventional CSM systems are thus not easily ported to other CSM providers that require other features, without editing the code. This makes each deployment expensive and time consuming. It also requires relatively skilled computer programmers for each deployment.

What are needed therefore are improved CSM methods, systems, and computer programs.

### BRIEF SUMMARY OF THE INVENTION

The following summary of the invention provides an understanding of at least some aspects of the invention. The summary is not an extensive overview of the invention. It is not intended to identify key or critical elements of the invention nor is it intended to delineate the scope of the invention. Its sole purpose is to present some concepts of the invention in a simplified form as a prelude to the more detailed description that is presented later.

The present invention is directed to improved CSM methods, systems, and computer program products.

A CSM system in accordance with the invention is designed to direct an incoming service request to an agent in less than 3 seconds using a contextual screen and to enable a highly collaborative environment with large number of simultaneous incoming service requests and CSM agents. A CSM system in accordance with the invention can provide:

an ability to define service activities according to timetable, qualification, user form, severity and business rules;

an ability to define Service Level Agreements (“SLAs”) and to align the service center resources with customer expectation;

an ability to dynamically build an agent dashboard with each incoming customer contact to reflect the overall customer context, wherein depending on specifics relating to customer context, service activity context, request context, CSM team context and knowledge context, the dashboard intuitively suggests the proper next steps in resolving the case;

an ability to build a unique point of contact for all information accessible through multiple channels to structure and organize all human, knowledge and technical resources and to permit collaborative effort to optimize the most efficient business processes at the lowest possible cost;

a knowledge base and associated tools to manage, publish, and utilize these knowledge base for case resolution;

geo-localization features, such as case transfer based on the geographical location of a customer or CSM field agent;

an ability to integrate with other CSM systems and/or to integrate with CRM systems; and

Web service support and associated integration capabilities based on SML industry standards.

The CSM system is also configurable for different levels of integration with customers and partners.

The CSM systems and computer program products are pre-encoded with a broad array of features that can be selected and configured for particular situations through graphical user interfaces (“GUIs”). This allows for faster and less expensive deployments because new code does not need to be written or edited during deployment. It also allows CSM systems to be deployed by individuals who do not have computer programming skills.

Further embodiments, features, and advantages of the present invention, as well as the structure and operation of the various embodiments of the present invention, are described in detail below with reference to the accompanying drawings. These aspects are indicative of but a few of the various ways in which the principles of the invention may be employed, and the present invention is intended to include all such aspects and their equivalents. Further features and advantages will be apparent to a person skilled in the art based on the description set forth herein and/or may be learned by practice of the invention.

It is to be understood that both the foregoing summary and the following detailed description are exemplary and explanatory and are intended to provide further explanation of embodiments of the invention as claimed.

### BRIEF DESCRIPTION OF THE FIGURES

The accompanying drawings, which are incorporated herein and form part of the specification, illustrate the present invention and, together with the description, further serve to explain the principles of the invention and to enable a person skilled in the pertinent art to make and use the invention. In the drawings, like reference numbers indicate identical or functionally similar elements. Additionally, the leftmost digit(s) of a reference number identifies the drawing in which the reference number first appears.

FIG. 1 is a block diagram of an example conceptual rendering of a CSM system.

FIG. 2 is a block diagram of example computer-based functional blocks of the CSM system.

FIG. 3 is a high level process flowchart 300 illustrating operation of the CSM system.

FIG. 4 is a process flowchart illustrating configuration of the CSM system

FIG. 5 is a conceptual illustration of service context.

FIG. 6 is a block diagram of an example conceptual rendering of case resolution.

FIG. 7 is a block diagram of an example customer organization.

FIG. 8 is an illustration of an example case management scenario for managing customer service with a CSM system.

FIG. 9 is process flowchart illustrating an example case creation process.

FIG. 10 is a process flowchart illustrating an example method of implementing agent case creation.

FIG. 11 is a process flowchart illustrating an example method of providing email access to the CSM system.

FIG. 12 is a process flowchart illustrating an example method of case creation from emails.

FIG. 13 is a process flowchart illustrating an example method of providing access to the CSM system through a self service portal.

FIG. 14 is a process flowchart illustrating an example method of case creation through a self service portal for authenticated users.

FIG. 15 is a process flowchart illustrating an example method of case creation through a self service portal for non-authenticated users.

FIG. 16 illustrates an exemplary computer useful for implementing components and modules of the invention.

FIG. 17 is a process flowchart illustrating an example method for enhancing customer service management.

Detailed Description of the Invention
Table of Contents

| I. | Introduction | | 8 |
|---|---|---|---|
| II. | Customer Service Management Overview | | 16 |
| III. | Example Customer Service Management System | | 17 |
| IV. | Methods of Managing Customer services | | 22 |
| | A. | CSM Configuration | 23 |

| | | |
|---|---|---|
| 1. | Interviews | 23 |
| 2. | CSM Tool Configuration | 24 |

| | | |
|---|---|---|
| a) | Customer Context | 25 |
| b) | Product and Service Qualifications | 25 |
| c) | Dependencies | 26 |
| d) | CSM Organizational Information | 27 |

| | | |
|---|---|---|
| (1) | Queues | 28 |

| | | |
|---|---|---|
| e) | Rules | 28 |

| | | |
|---|---|---|
| (1) | Case Creation Rules | 28 |
| (2) | Routing Rules | 29 |
| (3) | Transfer Rules | 30 |
| (4) | Collaborative Rules | 30 |
| (5) | Escalation Rules | 31 |
| (6) | Tools and Resources Rules | 31 |
| (7) | Case closing rules | 31 |

| | | |
|---|---|---|
| f) | Service Context, Permissions, Display Content | 32 |
| | and Formats | |
| g) | CSM System Configuration | 32 |

| | | |
|---|---|---|
| B. | Case Management | 33 |

| | | |
|---|---|---|
| 1. | User Interfaces | 35 |

| | | |
|---|---|---|
| a) | Dashboard GUIs | 35 |
| b) | Self-Service Portals | 37 |
| c) | Partner Interfaces | 38 |
| d) | Additional Interface Modes | 39 |

| | | |
|---|---|---|
| 2. | Case Creation | 39 |

| | | |
|---|---|---|
| a) | Agent Case Creation | 40 |
| b) | Electronic Mail Case Creation | 44 |
| c) | Self Service Portal Access and Case Creation | 47 |

| | | |
|---|---|---|
| 3. | Resolution | 50 |

| | | |
|---|---|---|
| a) | Field Service and Geo-Localization | 52 |

| | | |
|---|---|---|
| C. | Reporting and Statistics | 53 |

| | | |
|---|---|---|
| V. | Example Computer Implementation | 54 |
| VI. | Conclusion | 56 |

### I. INTRODUCTION

Methods, systems, and computer program products are described herein for customer service management (“CSM”). The methods, systems and computer program products are useful, for example, in managing customer service requests from one or more customers. The invention is not, however, limited to CSM. Based on the description herein, one skilled in the relevant art(s) will understand that the methods, systems and computer program products described herein can be implemented in other contexts, such as client relationship management (“CRM”).

The present invention now will be described more fully hereinafter with reference to the accompanying drawings, in which embodiments of the invention are illustrated. This invention may, however, be embodied in many different forms and should not be construed as limited to the embodiments set forth herein. Rather, these embodiments are provided so that this disclosure will be thorough and complete, and will fully convey the invention to those skilled in the art.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The following definitions are provided to assist the reader in understanding the description below. Additional definitions are provided throughout the specification.

“CSM system” refers to a computer program product running on one or more computer systems to implement one or more CSM functions, including any databases and/or data objects created by the computer program product to implement the CSM function(s). A CSM system can be implemented to provide CSM for multiple customers.

“CSM entity” or “CSM organization” refers to an entity or organization that implements a CSM system to manage customer service requests.

“Customer” refers to a person or entity for whom the CSM organization manages customer service requests. Customer entities can include privately owned entities, government entities, for-profit entities, and/or non-profit entities. Customer entities can range from relatively simple entities to relatively complex entities that have multiple sub-entities, such as divisions or departments, subsidiaries, stores, branches, franchises, outlets, warehouses, or offices, possibly at geographically diverse locations.

The CSM system is configurable to provide different types of CSM to different customers, and to different sub-entities within a customer.

The CSM system is configurable for deployment wholly within a “customer” organization, wherein customer service requests come from within the same organization.

The CSM system is also configurable to provide CSM to third parties on behalf of the customer. This can be useful, for example, where the customer provides products or services to the third parties, such as other entities or consumers, and desires to provide customer service support to the third parties. In such a case, the customer can provide the third parties with contact information or links to the CSM entity. The third parties need not even know that the CSM provider is distinct from the CSM customer.

“Partner” is an entity or individual from whom the CSM organization seeks assistance in managing customer service requests. A partner can be, for example, a company that sells products or services, wherein customer service for the product or service is provided by the CSM entity to purchasers of the products or services.

“Users” are individuals who are permitted to access a CSM system. Users can be associated with a CSM organization, a customer, or a partner, or in some situations, a non-customer in need of assistance regarding a customer (e.g., buyers of products or services from the customer).

“Agents” are users within a CSM organization.

“Administrators” are users who are authorized to configure the CSM system for a CSM organization.

“Partner agents” are users within a partner organization.

“Self-service users” are entities or individuals who are permitted limited access to the CSM system for customer support. Self-service users can be current customers or non-customers in need of assistance.

“Customer contacts” are individuals within a customer organization who are authorized to request customer service from a CSM organization.

“Case” or “case record” refers to a collection of information associated with a customer service request. A case can include one or more database entries, data objects, or the like. A case record includes customer context information, service context information, and case qualification information, which are described below. A case record includes a free text field for storing user-inputted text associated with the case. A case record optionally includes a history field that records actions taken with respect to the case (e.g., transfer or resolution information). A case record optionally includes attached files such as, for example and without limitation, text files, graphic files, video files, and audio files.

Cases are thus very rich in content, in that they include a great deal of information. As described below, process efficiencies are obtained by limiting the amount of case information that is presented to users, based on the users' roles, responsibilities, and need to know. By reducing or eliminating the amount of unnecessary information presented, users are better able to quickly perform their assigned tasks. As is described below, cases are routed to CSM agents or teams based on the customer context, service context, and/or case qualifications.

“Customer context” or “customer qualifications” refer to a collection of information associated with a customer. This can include, for example, and without limitation, customer identification, customer contact identification, contractual obligations between the customer and the CSM organization, and customer account and/or sub-account information.

“Contracts” refer to legal agreements related to billing of customers for the services provided to them. A customer may have one or more contracts with a CSM organization. Contract pricing can be based on any of a variety of variables, such as the maximum number of customer users, number of concurrent access seats, per service request, per period of time, and/or by service type. Further, billing can be made on a flat-fee basis, based on credit (in hours, days, or units), or per service request (number or service requests).

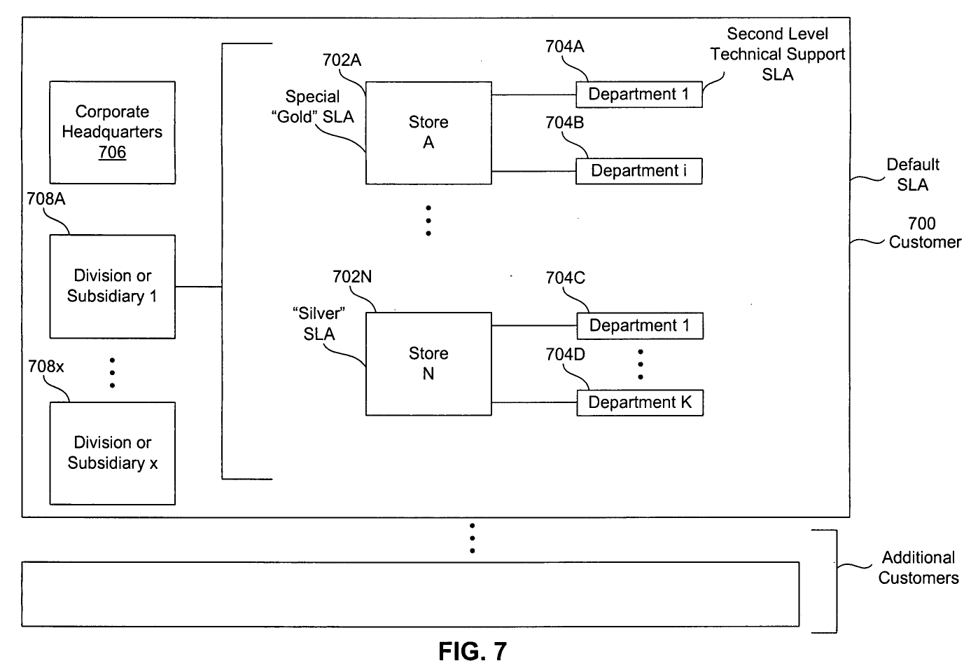

FIG. 7 is a block diagram of an example customer organization 700, including corporate headquarters 706 and a number of divisions and/or subsidiaries 708. In the example of FIG. 7, the division or subsidiary 708A is associated with multiple stores 702, at least some of which include one or more departments 704. Any one or more of headquarters 706, divisions or subsidiaries 708, stores 702, departments 704, and/or contacts within any of these entities, can enter into a contract with a CSM provider. The CSM provider can enter into contracts with other customers as well.

“Accounts” and “sub-accounts” refer to user-definable relationships between a CSM organization and a customer. Generally, contracts specify the legal rights and responsibilities of the parties, while the accounts serve more as a management tool. Account information can be used in conjunction with other customer context information and/or SLAs to determine case routing and resolution requirements.

An account can be associated with, for example, an entire customer organization, a division, a department, an individual within the customer organization, a customer product or product line, service type, and/or any other desired feature(s).

Multiple accounts can be associated with a given customer. For example, in FIG. 7, any one or more of headquarters 706, divisions or subsidiaries 708, stores 702, departments 704, and/or contacts within any of these entities, can be associated with an account or sub-account. A first account can be associated with division 708A, stores 702, and corresponding departments 704. Such an account may be referred to as a retail stores account for the customer 700. A second account can be associated with corporate headquarters 706.

Where multiple accounts are associated with a customer, a particular account can be selected by a customer at the initiation of a new case. Alternatively, an account can be selected automatically by the CSM system based on customer context, dependencies, and optionally case qualifications.

A single contract can govern the legal rights and responsibilities for multiple accounts. Alternatively, each account can be associated with its own contract. Alternatively, an account can be associated with multiple contracts. For example, in FIG. 7, division or subsidiary 708 can enter into a general contract with the CSM provider, while each store 702 enters into a separate more detailed contract with the CSM provider.

“Case qualifications,” “product qualifications,” and “service qualifications” refer to a collection of information regarding the nature of a case, product, or service. Case qualification information can include, for example, and without limitation, a product or service type (e.g., digital camera), manufacturer name, model number, and the like.

“Dependencies” refer to relational links between data field entries. Dependencies are used, for example, to determine subsequent selections that are presented to a user during case creation, based on prior data entries or selections. For example, dependencies can be specified between customer context information, case qualification information, and/or service qualification information. Dependencies reduce the number of selections or data entries required of users, and thus improve the efficiency of the CSM process.

“Tools” refer to rights and abilities to take actions. Tools include action tools, process tools, and resource tools. Action tools refer to the right/ability to initiate an action with respect to cases, such as create, resolve (e.g., to answer or provide information), save, and close. Process tools refer to the right/ability to transfer cases, and to whom (e.g., to a team, a user, a queue, or by geo-localization), and the right/ability to create parent or child cases. Resource tools can include internal resources, such as the CSM knowledge base, and external resources, such as the shipment tracking systems, manufacturer databases, warehouse databases, and internet resources.

“Service level agreements” (“SLAs”), refer to levels of service to be applied to cases (e.g., priority, expediency, agent skill levels, and/or available tools). These may include, without limitation, the types of services to be performed by the CSM provider, time periods within which the services are to be provided, and the level of expertise/expediency with which these services will be provided. SLAs can be associated with, for example, and without limitation, customers, customer contacts, contracts, accounts, sub-accounts, and/or products and services for which the CSM organization manages customer service inquiries. SLAs can also be associated with CSM teams or agents, product/service qualifications, or queues, which are described below.

In the example of FIG. 7, the customer organization 700 is associated with a default SLA. Thus, unless another SLA overrides this, any customer service inquiry from the customer 700 will be handled according to the default SLA. Store 702A is associated with a special “gold” level SLA, which can be a higher level of service than the default SLA. Department 704A is associated with a second level technical support SLA, which can be a lower level of service than the default SLA. Store 702n is associated with a “silver” level SLA which is a lower level of service than the gold level, and which can be higher or lower than the default SLA. Headquarters 706 and/or one or more of the divisions or subsidiaries 708, or entities associated therewith, can also be associated with SLAs. In addition, individuals or contacts associated with headquarters 706, divisions or subsidiaries 708, stores 702, or departments 704, can be associated with SLAs. These SLAs will typically take precedence over the default SLA, based on rules selected by the administrator. Where there is no associated SLA, the default SLA will apply. For example, departments 704B, C, and D do not have associated SLAs, thus service calls from these departments will be handled according to the default SLA.

“Team context” refers to a collection of information that is used to determine to which team or agent a case is routed. Team context can include, for example, and without limitation, SLA information and/or CSM context information, such as team and/or agent availability schedules and/or levels of expertise.

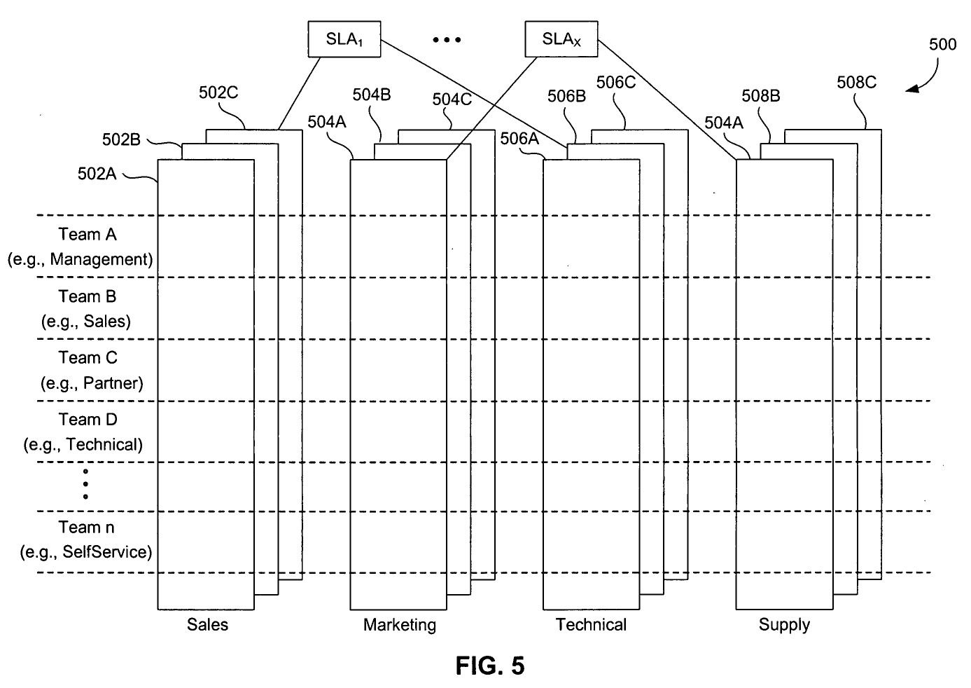

FIG. 5 is a conceptual illustration of an example service context environment 500. Each vertical column represents a CSM service context or service option. For example, columns 502A, B, and C, represent sales service contexts. Columns 504A, B, and C, represent marketing service contexts. Columns 506A, B, and C, represent technical service contexts. Columns 508A, B, and C, represent supply service contexts.

One or more of the service contexts can be associated with corresponding SLAs. Customer service requests associated with columns that do not have a corresponding SLA, will be handled according to a customer default SLA or other SLA.

The horizontal rows in FIG. 5 represent areas of responsibility for various CSM teams or partner teams. Different teams can be responsible for different aspects of a service contexts. The different aspects can be distinguished from one another by, for example, case qualifications or accounts. Thus, a customer service request associated with a given service context can be routed to different teams depending upon, for example, case qualifications.

In the example of FIG. 5, each CSM team is illustrated as having responsibility for some aspect of a given service context. This is not, however, necessarily always the case. In some situations, a given CSM team might not have responsibility for one or more of the service contexts.

Recall that cases are very rich in content, in that they include a great deal of information. As can be seen from FIG. 5, most users have a need for only a portion of the overall information available. Thus process efficiencies are obtained by limiting the amount of case information that is presented to users, based on the users' roles, responsibilities, and need to know. Control over the information content and format provided to users is described below with respect to configuration of a CSM system.

In FIG. 5, one or more of the CSM teams can have an associated SLA. The CSM system can be configured so that such a team SLA will override any other SLA.

### II. CUSTOMER SERVICE MANAGEMENT OVERVIEW

A CSM system, as described herein, is configurable for a variety of different implementations. All or substantially all of the selectable and/or configurable functionality is pre-encoded in software. Graphical user interfaces allow administrators to configure the tool for particular implementations. This eliminates the need for customized software encoding. This also allows a single version of the CSM system to be used for multiple deployments, which spreads development costs among multiple CSM organizations. This, in turn, reduces the cost of the CSM system per CSM organization.

The description herein provides a number of example features that can be pre-encoded in a CSM system, which are selectable and configurable by an administrator. The invention is not, however, limited to the example features described herein. Based on the description herein, one skilled in the relevant art(s) will understand that other features can be pre-encoded.

A CSM system, as described herein, is typically embodied as a software package that includes computer readable instructions for causing a computer system, on which the software package is installed, to perform certain functions. Example functions provided by computer readable instructions are described below.

The computer readable instructions typically include instructions that cause the computer system to generate one or more databases in memory. The databases are used to maintain records regarding customers and cases. Unless otherwise specified herein, the one or more databases within the CSM system are collectively referred to herein as a single database.

The computer readable instructions typically include instructions that cause the computer system to generate graphical user interfaces (“GUIs”) for use by an administrator. The administrator GUIs allow administrators to configure the CSM system by entering data and selecting and configuring desired rules.

The computer readable instructions typically include administrator selectable rules and associated links that govern generation of cases, work flow of cases, generation of reports and statistics, generation of user GUIs, and accessibility of tools.

The computer readable instructions typically include instructions that cause the computer system to generate user GUIs, including agent dashboard GUIs, in accordance with the administrator selections. The user GUIs allow users to create and manage cases in accordance with rules configured by the administrators.

### III. EXAMPLE CUSTOMER SERVICE MANAGEMENT SYSTEM

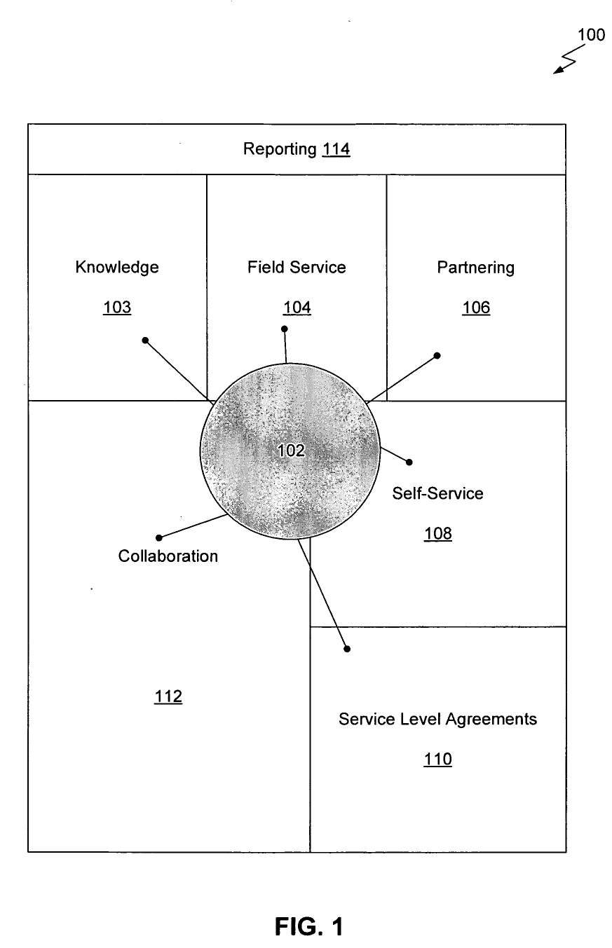

FIG. 1 is a block diagram of an example conceptual rendering of a CSM system 100. The CSM system 100 can be implemented in software to be executed by a computer system, as described above. Alternatively portions of the CSM system 100 are implemented in hardware. The example components of the CSM system 100 are for illustrative purposes. A CSM system, in accordance with the invention, can include any one or more of the example components illustrated in FIG. 1.

The CSM system 100 includes a case management function 102, which is integrated with most, if not all aspects of the CSM system 100, as described in sections below.

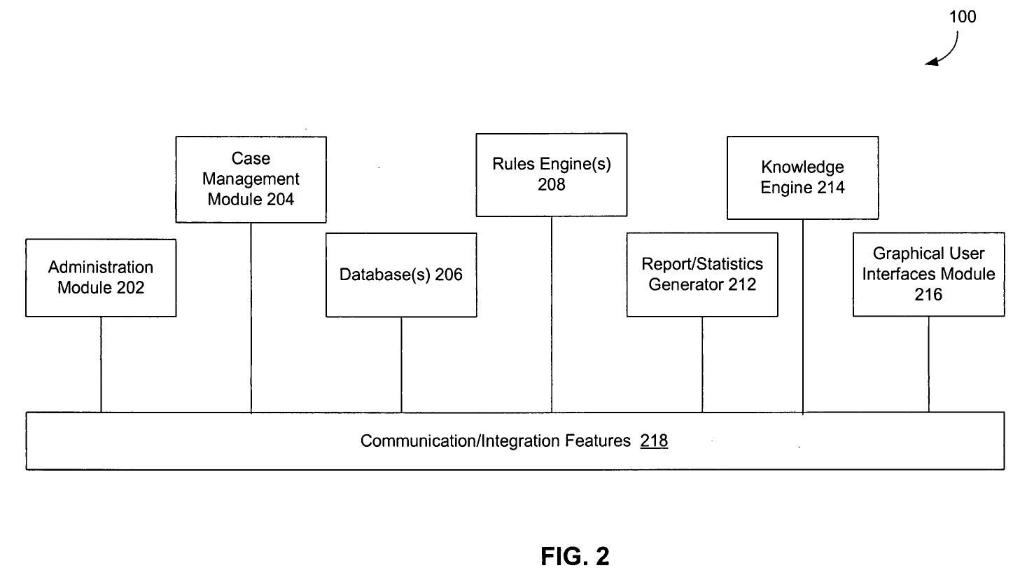

A knowledge function 103 provides agents with information that is potentially relevant to a case or a customer inquiry. The knowledge function 103 is described further below with respect to FIG. 2.

A field service function 104 interfaces with field service agents. The field service function 104 is described in sections below.

A partnering function 106 interfaces with one or more partnering entities. Partnering entities can include entities that provide products and or services for which customer service requests are received by the CSM organization. Cases that are associated with such products and/or services can be transferred to the partnering entities for resolution.

A self service function 108 interfaces with external users, such as customers or potential customers, through for example, an internet portal. The self service function 108 can be configured to allow users to create or view cases, and/or request information without necessarily opening a case, such as store hours, product availability, pricing, contact information, and directions.

A service level agreement (“SLA”) function represents the management and enforcement of various SLAs that govern case creation and management within the CSM system 100. As noted above, and as described below, SLAs specify the level of service to be provided to a given case, based and context information and/or qualification information. Levels of service can encompass required time to resolution, resources to be employed, and the like.

A collaborative function 112 represents collaboration on cases by multiple agents and/or teams within the CSM organization, and/or optionally with partnering organizations. Collaborative function 112 represents, for example, parent/child case management.

A reporting function 114 represents reporting and statistics capabilities of the CSM system 100. The reporting function 114 permits agents, and optionally, customers and/or partnering organizations, to view cases, including pending and resolved cases, statistics associated with the cases, such as time to resolution, statistics associated with agents and/or teams, such as performance statistics, and any other information maintained by the CSM system 100. Access rights to the reporting function 114, including information content and format, are generally specified by an administrator. The administrator can provide users with certain selectable function such as date ranges, formatting options, and levels of detail.

FIG. 2 is a block diagram of example functional blocks of the CSM system 100, which can be implemented with computer readable instructions and/or logic. In the example of FIG. 2, the CSM system 100 includes an administration module 202, a case management module 204, one or more databases 206, a rules engine 208, a report and statistics generator 212, a knowledge engine 214, and a GUI module 216. The functional blocks are interconnected with one another by communication/integration features 218.

The GUI module 216 includes logic and/or pre-encoded computer instructions that cause a computer system on which the CSM system 100 is installed to generate a variety of GUIs. The GUIs include administrator GUIs and agent GUIs, and optionally customer GUIs and partner GUIs. The GUIs are configured by the administrator to present users with information and tools according to the users' roles and responsibilities. The CSM system 100 can be designed to allow the administrator to select and configure pull-down menus, side-bars, tabs, content, and display formats.

The administration module 202 allows an administrator to configure the CSM system 100, through one or more administrator GUIs. Through the administrator GUIs, the administrator is prompted to input customer context information, product/service qualifications, service context information, and CSM organizational parameters. The administration module 202 also allows the administrator to select access rights, information display content, information display formats, dependencies (described below), and case creation and management rules. The administration module allows the administrator to map sets of context information to desired work flow parameters. Thus, when a case is created having one of the sets of context information, the case is automatically routed to an agent or team.

The one or more databases 206 are configured with the information and selections provided by the administrator. The configuration is performed by computer readable instructions included as part of the CSM system 100. The computer readable instructions are pre-encoded so that the database configuration is performed automatically, that is, without writing new code at the time of configuration.

The rules engine 208 includes a myriad of pre-encoded, administrator-selectable rules and configuration parameters. The rules and configuration parameters are presented to the administrator through the administrator GUI in a user-friendly fashion, as described in sections below.

The case management module 204 includes computer readable instructions that cause the computer system to create cases, optionally including parent/child cases, in the one or more databases 206. The case management module 204 also includes computer readable instructions that cause the computer system to route cases, transfer cases, escalate cases, and close cases, in response to agent commands, and in accordance with the administrator selected rules. Case history information, such as case assignment, whether from rules-based routing, or agent initiated transfer, along with case status (e.g., pending or closed) and resolution information, is maintained in the one or more databases 106, typically within one or more fields associated with the corresponding cases.

The report and statistics generator 212 includes computer readable instructions that cause the computer system to generate reports and statistics. The report and statistics generator 212 is configured by the administrator module in response to input from the administrator. The configuration includes selecting and configuring rules for reporting case resolution to customers, assigning permissions to users to generate reports and statistics, and defining information content and format.

Knowledge engine 214 provides users with knowledge to assist the users in resolving cases and/or inquiries. The knowledge can include technical information related to product or services for which customer service is being provided. Technical knowledge may be based on resolutions to prior cases and/or on information otherwise provided by technical personnel. The knowledge can also include best practices. The knowledge can also include account information, contract information, customer contact information, store hours, and the like. The knowledge is contained in the one or more databases 206. The knowledge engine 214 controls the selection of relevant knowledge and the presentation of the knowledge to users.

The knowledge database entries can be associated with product or service qualification information, such as product models. In such a situation, the knowledge engine 214 compares the product or service qualification information of a case to product or service qualification information in the knowledge database. When similar qualification information is identified in the knowledge database, the corresponding knowledge is made available to the user. The knowledge can be automatically presented to the user without prompting, or can be provided upon a user request. The knowledge engine 214 typically runs continually in the background when an agent creates a case and/or opens a case to attempt resolution.

The knowledge engine 214 optionally includes key-word, free text, and/or natural language search capabilities.

The communication/integration features 218 represent one or more of a variety of communications and interfacing functions between the functions described above, between the CSM system 100 and users, and between the CSM system 100 and other tools.

For example, in addition to the GUIs discussed above, the CSM system 100 can be configured to interface with customer and/or partners through one or more of a variety of other types of interfaces such as, for example, conventional telephony (i.e., speech-to-speech), automated telephony (e.g., touch tone or voice recognition), text-to-speech and/or speech-to-text systems, electronic mail, instant messaging, text messaging, short messaging (SMS), facsimile, and/or conventional mail. For reception of electronic text, the communication/integration features 218 can include hardware and/or software for parsing relevant information from the communication such as customer context information and/or case qualification information. This information can be inserted directly into a new or pending case.

The CSM system 100 can be integrated with other CSM systems and/or with client relationship management (CRM) tools, such as sales and/or marketing CRM tools. A variety of integration features, including data exchange formats and protocols can be pre-encoded within the CSM system 100. The integration features are presented to an administrator for selection and configuration. The integration features can be implemented in part by the communication/integration features 218.

### V. METHODS OF MANAGING CUSTOMER SERVICES

Methods of configuring and implementing CSM functions are provided below. The methods are described in terms of the example CSM system 100. The methods are not, however, limited to implementation with the example CSM system 100. Based on the description herein, one skilled in the relevant art(s) will understand that the methods can be implemented with other CSM systems. Such other implementations are within the spirit and scope of the present invention.

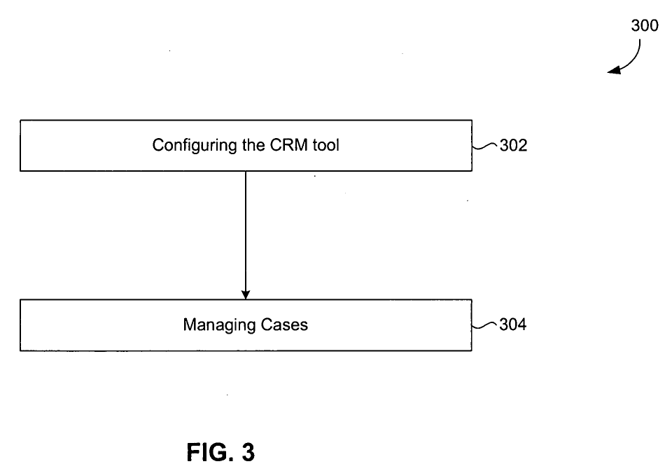

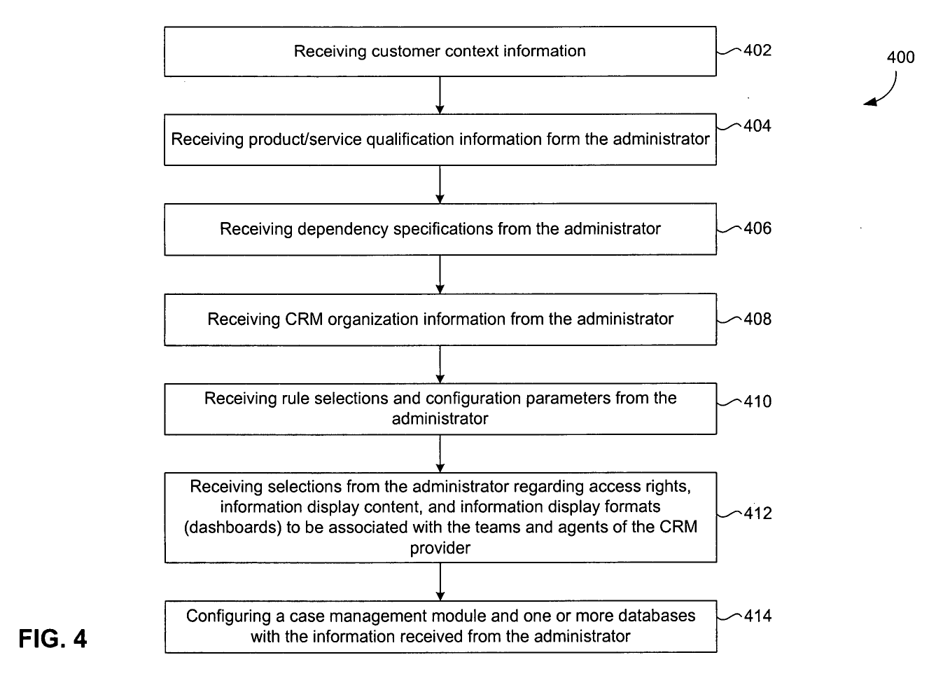

FIG. 3 is a high level process flowchart 300 illustrating implementation of the CSM system 100. Step 302 includes configuring the CSM system 100. This is performed by one or more administrators as is described below with reference to FIG. 4.

Step 304 includes managing cases. Case management includes case creation, routing, resolution, and reporting. Case routing refers to the assignment of a case to a responsible team and/or team member for resolution. Routing actions include initial routing based on rules, case transfer, and case collaboration (e.g., parent/child processing). Case resolution refers to actions taken with respect to a case by the responsible team, agent, and/or partner. Reporting includes reporting case resolution and providing statistics.

CSM system configuration (step 302) is described immediately below. Case management (step 304) is described further below.

### A. CSM Configuration

CSM system configuration is performed as part of a deployment process. The deployment process includes gathering information that will be needed during the configuration process. The information gathering process can be performed through in-person interviews and/or computer-based questioning. The CSM system is then configured with the gathered information. The CSM system can be configured to implement existing CSM procedures, or can be configured to provide new CSM procedures features.

Interviewing is described immediately below. Configuration of the CSM system is described further below.

1. Interviews

Interview topics typically include customer context information, such as names of customer organizations, entity groups within the customer organizations (e.g., divisions, subsidiaries, departments (e.g., sales, marketing, parts, repair, warranty, etc.), stores, branches, franchises, outlets, warehouses, or offices), names of customer contacts, contracts between the CSM organization and the customers, accounts and/or sub-accounts, and any service level agreements.

Interview topics also include case qualification information for products and/or services for which CSM is to be provided.

Interview topics also include CSM organizational parameters, such as case management teams and agents within the CSM organization. These can include receptionist teams, technical support teams (e.g., research and development and/or trouble shooting teams), sales support teams, and management support teams. CSM organizational parameters can also include team availability schedules.

Interview topics also include existing or desired work flow parameters within the CSM organization, such as case creation rules, case transfer rules, case closure rules, case escalation rules, collaboration rules, partnering rules, and tools availability.

Interview topics also include existing service levels provided by the CSM organization.

Interview topics also include desired content and format of GUIs and reporting/statistics functions.

2. CSM Tool Configuration

After the interview process is complete, or as the interview process is performed, the CSM system 100 is configured by an administrator with the information obtained during the interview process. The administrator configures the CSM system 100 through the administrator module 202 (FIG. 2).

With information and selections provided by the administrator, the administrator module 202 names, and when necessary, creates new fields (e.g., customers, accounts, sub-accounts, contacts, product/service qualifications, dependencies, teams, agents, availability schedules, partners, and service level agreements), within the database 206.

With information and selections provided by the administrator, the administrator module 202 also configures the case management module 204 with rules that govern case creation and case management. The administrator module also configures the report/statistics generator 212 for reporting and statistics generation. The administrator module also configures the look, feel, and content of GUIs. Configuration is further described below with respect to FIG. 4.

FIG. 4 is a process flowchart 400 illustrating an example implementation of step 302, configuring the CSM system 100.

The process flowchart 400 begins by presenting an administrator with one or more GUIs to an administrative portion of the CSM system. In an embodiment, the one or more administrator GUI's include a matrix of selectable features or rules that can be checked-off or otherwise highlighted to select desired features. Where appropriate, necessary variables are linked with the rule, such as customer context information, case qualification information, and/or service context information. Linking can be initiated by the administrator or automatically based on administrator selections.

a) Customer Context

Step 402 includes receiving customer context information from the administrator through the administrator GUI, for each CSM customer. The customer context information typically includes an identification or definition of one or more customers and any associated contracts, accounts, sub-accounts, contacts, and service level agreements (“SLAs”).

b) Product and Service Qualifications

Step 404 includes receiving product or service qualification information from the administrator, through the administrator GUI. The product or service qualification information includes an identification of one or more products and/or services for which the CSM organization is prepared to receive customer queries.

The administrator will optionally be prompted to specify any case sub-qualifications. For example, where the products include video cameras, sub-qualifications may include one or more video camera manufacturers. Further sub-qualifications may include model numbers associated with each manufacturer or other identification information.

c) Dependencies

Step 406 includes receiving dependency specifications from the administrator, through the administrator GUI. Dependencies are used to determine subsequent selections that are presented to users during case management.

For example, during case creation, when an agent identifies a portion of the customer context information, dependency rules can determine some or all of the remaining associated customer context information and automatically populate the associated fields in the agent's dashboard GUI. If there are multiple contracts, contacts, or accounts associated with a customer, dependency rules can cause the CSM system to present the agent with the limited set of contracts, contacts, and/or accounts associated with the identified customer.

Dependencies can also be specified for product/service qualifications.

Dependencies can also be specified between customer context information and product/service qualifications. For another example, during case creation, when an agent identifies a customer, dependency rules can dictate that the agent is presented with a limited list of only those products or services for which the customer has contracted with the CSM organization for service. When the agent selects a product or service from the list provided by the CSM system, dependency rules can dictate a list of sub-qualifications to select from.

In the example of FIG. 7, when a customer representative from a store 702 requests service from the CSM organization, the customer representative may not be able to identify the account or contract that governs the service request. Nevertheless, when the CSM agent enters the store or department into a new case template, or other identification information, dependency rules can trigger the automatic population of fields identifying the division, customer, account, contract, and/or SLA. Where the dependencies cannot completely populate all customer context fields, they can cause the presentation of a limited sub-set of customer context information from which the caller can select.

Once the customer context information is entered into the case creation template, the dependencies can cause the presentation of a limited sub-set of case qualification information associated with the contract or account, from which the agent or customer can select. For example, where the customer context information identifies department 704A, dependencies can cause the presentation of only those products or services that are associated with department 704A.

Dependency rules thus reduce the number of selections from which an agent or customer has to select from. Dependency rules permit required data fields to be filled quickly, typically within seconds. This allows a user to create many more cases in a given time period than would otherwise be possible. This increases the overall efficiency of the CSM organization. Other dependency options can also be implemented.

d) CSM Organizational Information

Step 408 includes receiving information from the administrator, through the administrator GUI, regarding the CSM provider (e.g., service context information). This can include, without limitation, identification of one or more of teams, agents, availability schedules, and SLAs, to be managed by the CSM system.

Note that SLAs associated with the CSM organization can be overriden by SLAs associated with customer context information, and vice versa. For example, a customer SLA may specify a set of processing parameters for cases. The administrator can configure the CSM system so that such cases are routed to a selected team or agent. The selected team or agent may have their own associated SLA that includes more stringent processing parameters. The administrator can configure the CSM system to apply the agent or team SLA in place of the customer SLA.

(1) Queues

In an embodiment, a CSM system maintains all cases within a single computer processing queue. Alternatively, the CSM system can be configured with multiple queues. Multiple queues can be useful for case management purposes and/or for statistics reporting. For example, and without limitation, queues can be configured for different CSM teams, such as research and development, testing, quality assurance, sales, and/or marketing. Queues can also be configured for customers, partners, service levels, and/or products/services. Statistics can be generated for different queues to monitor distribution of work load, staffing levels, response times, and/or contract parameters.

e) Rules

Step 410 includes receiving information from the administrator, through the administrator GUI, selecting rules to be applied by the CSM system for case creation and management. The rules can include rules for case creation, routing, transfer, collaboration, escalation, tools access, and case closing. These rules are new described. The invention is not, however, limited to the example rules herein.

(1) Case Creation Rules

Case creation rules specify who can create new cases, such as specific agents, teams, customers, customer contacts, partners, and/or other users. Case creation rules also specify fields to be populated for a case, such as customer context fields and qualification fields. Case creation rules can include GUI formats and content that will be displayed in a new case template. The new case template optionally includes scripted questions that have been selected and/or configured by the administrator. The administrator can configure different sets of scripted questions for different customers and for self help portals. The scripted questions are posed to customers by the CSM agents, or directly to self help users.

(2) Routing Rules

Routing rules determine the team, agent, or partner, to which a case is assigned for resolution. Routing rules allow the administrator to map sets of context information, such as customer context information, case qualification information, and SLA requirements, to agents, teams, or partners. Thus, when a case has a given set of context information, the case is automatically routed to an agent, team, or partner.

Routing rules can take into account team or agent availability. For example, where a resolution is required within three hours (e.g., by an applicable SLA), a first team may only be available for the next hour. A second team may only be available beginning in two hours. Rules are selected by the administrator for such situations to route the case either to the first team or the second team. Alternatively, the rules can provide that the case be assigned to the first team, and if the case is not resolved at the end of the first hour, the case is transferred to the second team, or the case is escalated to a supervisor for transfer to the second team. Escalation is described below.

Routing rules apply to parent and child cases created for collaboration, which is described below.

Routing rules optionally include dynamic routing rules. Dynamic routing rules take into consideration one or more real-time factors, such as current agent or team work load, availability schedules, and queue depth.

(3) Transfer Rules

Case transfer rules specify permissions for transferring cases. Permissions can be applied according to team and/or agent. Permissions govern who can transfer cases, and to whom the cases can be transferred to. Transfer authority can be further limited by case qualification and/or customer context. Transfer authority can be limited to transfer of cases only to certain other agents or teams. Case transfer rules can specify that when an agent attempts to transfer a case, the case is escalated to a supervisor for approval or disapproval of the transfer. Case transfer rules can specify whether transferred cases keep their prior SLA or takes on a new SLA. Case transfer rules can specify whether case histories will include a record of any transfers.

(4) Collaborative Rules

Collaborative rules enable and configure collaborative efforts between multiple agents, teams, and/or partners. Collaborative rules are generally associated with parent/child cases. Parent/child cases include two situations. The first situation is where a case can be separated into multiple sub-cases, or child cases, each child case associated with its own issue. Rules can be selected so that, upon resolution of the child cases, the parent case is automatically closed.

The second parent/child situation is where multiple cases having related qualifications and/or problem descriptions. In this situation, a parent case can be created to associate all of the related cases as “child” cases. Rules can be selected so that, upon resolution of the parent case, the child cases are automatically closed.

Additional rules can be selected as to permissions for parent/child case creation, routing, and closing.

(5) Escalation Rules

Case escalation rules allow the administrator to specify circumstances that may arise with respect to a case, along with any actions to be performed as a result of the circumstance. Escalation can include notifying a supervisory agent of an issue, and/or providing the supervisory agent with a link to the escalated case. Such a link can be displayed in the supervisory agent's dashboard GUI.

For example, escalation rules can specify that when an agent attempts to close a case, the case is escalated to a supervisory agent for final review and actual closure. This can be useful, for example, for quality control.

As another example, where an SLA requires that certain cases be resolved within a given period of time, case escalation rules can escalate unresolved cases when the given period of time is close to expiration.

Case escalation rules can also be enabled for case transfers and collaboration. In such a scenario, an agent may not have permission to transfer cases or initiate collaboration, but instead, may be authorized to escalate a case to an agent with the appropriate authority.

The invention is not, however, limited to these example escalation scenarios.

(6) Tools and Resources Rules

Tools and resources rules specify tools and resources available to the CRM tool, and permissions for agents, customers, and partners for accessing the tools and resources.

(7) Case Closing Rules

Case closing rules specify permissions for closing cases, and any resultant actions. For example, case closing authority can be restricted to certain individuals or teams. Case closing rules also specify any actions to be taken upon case closing, such as reporting to the customer.

Case closing is typically performed upon resolution of a case. Case closing rules can also be implemented in other situations, such as, for example, where a case has been dormant for some period of time awaiting action from the customer.

Case closing rules can include rules for notifying a customer of the resolution. Such notification rules can include rules for automatically notifying customers over the internet, conventional telephony (i.e., speech-to-speech), automated telephony (e.g., touch tone or voice recognition), text-to-speech and/or speech-to-text systems, electronic mail, instant messaging, text messaging, short messaging (SMS), facsimile, and/or conventional mail.

f) Service Context, Permissions, Display Content and Formats

Step 412 includes receiving information from the administrator, through the administrator GUI, selecting and configuring any access rights, information display content, and information display formats, that have not been addressed above. The administrator can configure different display formats and content for agents, self help portals, and partners. The administrator can vary display formats and content according to customers context information, product/service qualifications, agents, and teams.

g) CSM System Configuration

Step 414 includes configuring case management module 204 (FIG. 2), and the database 206 with the information received from the administrator. In an embodiment, the case management module 204 and the database 206 are configured as the information and selections are received from the administrator. The CSM system includes pre-encoded computer readable instructions for creating and configuring the one or more databases according to the input received from the administrator.

After the CSM system is configured, processing proceeds to step 304, managing cases. Case management is described below.

The CSM system can be reconfigured by an administrator at any time to incorporate new customers, to incorporate changes within existing customers, and/or to incorporate changes within the CSM organization. The CSM system can also be reconfigured to optimize case management rules and/or to change GUI content and format. Reconfiguration of the CSM system is performed through the administrator GUIs, without needing to write additional code.

### B. Case Management

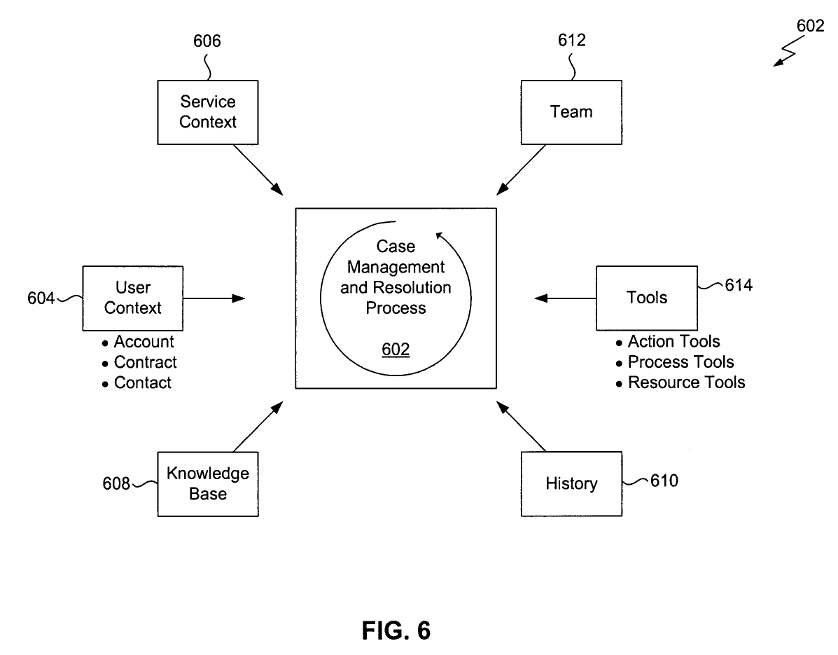

FIG. 6 is a conceptual diagram of a case management and resolution process 602 that receives customer context information 604, service context information 606, knowledge base information 608, and case history information 610. Case resolution actions are performed by agents or teams 612, using one or more tools 614. The one or more tools 614 can include action tools, process tools, and/or external tools.

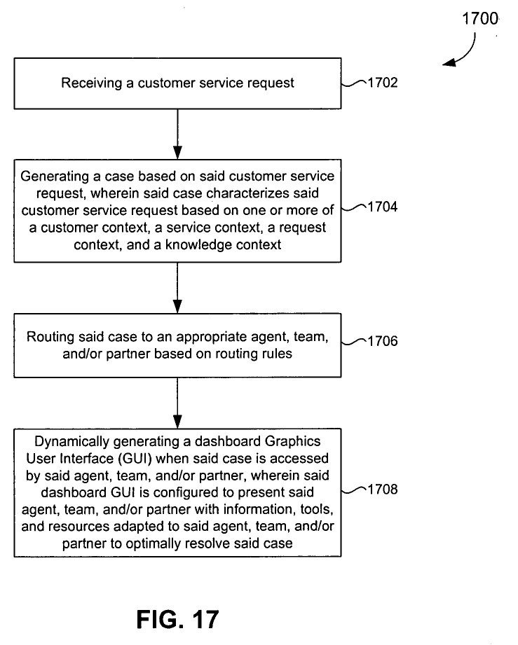

FIG. 17 is a process flowchart 1700 that illustrates a method for enhancing customer service management according to the concept described in FIG. 6. Process 1700 begins in step 1702, which includes receiving a customer service request. The customer service request may be received via email, phone, or the web through a live chat or a self-service portal.

Step 1704 includes generating a case based on the received customer service request, wherein the case characterizes the customer service request based on or more of a customer context, a service context, a request context, and a knowledge context. The customer context includes information related to one or more of a customer account profile, a customer contact profile, a service contract, a service level agreement (“SLA”), and a customer history. The service context includes information related to one or more of the severity of the requested service, time availability of the requested service, and business rules associated with the requested service. The request context includes information related to one or more qualifiers of the customer service request include question type, state, severity, and history. The knowledge context includes one or more of related customer service experience, related knowledge, and other contextual information.

Step 1706 includes routing the case to an appropriate agent, team, and/or partner based on routing rules. In an embodiment, the routing rules map context information including customer context, service context, and/or request context to agents, teams, and/or partners. In another embodiment, the routing rules are adaptive according to agent, team, and/or partner work load; agent, team, and/or partner availability, and queue depth of the different service processing queues. In a further embodiment, the routing rules account for geographical locations of agents, teams, and/or partners.

Step 1708 includes dynamically generating a dashboard Graphics User Interface (GUI) when the case is accessed by the agent, team, and/or partner. In an embodiment, the dashboard GUI is configured to present the agent, team, and/or parent with information, tools, and resources adapted to the agent, team, and/or partner to optimally resolve the case. In an embodiment, the information, tools, and resources are adapted according to duties and/or responsibilities of the agent, team, and/or partner. In another embodiment, the look and feel of the dashboard GUI varies according to one or more of the customer context, the service context, and the agent, team, and/or partner.

Case management (i.e., normal operation), is described below from the perspectives of agents and teams, customers (including email and self-service portals), and partners. Before describing case management operations, user interfaces are described.

1. User Interfaces

a) Dashboard GUIs

During case management, agents are presented with dashboard GUIs. The content and look-and feel of the dashboard GUIs are configured by the administrator to present agents with the information, tools, and resources they need to manage cases. Different agents' can be provided with different dashboard GUIs, depending on the agents' duties and responsibilities. The dashboard GUIs essentially act as filters to the database 206, in that not all of the available information is necessarily presented to the agents. Restricting the information provided to the agent allows the agent to more quickly focus on the information that is relevant to agent's role. Dashboard GUIs can be configured differently for agents, customer contexts, and/or product/service qualifications.

From the dashboard GUIs, depending upon access rights and responsibilities, agents can select to create new cases, open existing cases, take actions with respect to cases, access tools, and/or generate reports and statistics. Tools can include shipping and purchasing accounts, internal CSM resources such as the knowledge base, external resources, such as partner databases or other internet accessible databases, technical manuals, and shipment tracking resources. The invention is not, however, limited to these examples. The dashboard GUIs can be configured to provide these abilities to agents through pull-down menus, side bars, tabs, and/or hyperlinks.

Where the agent is tasked with resolving cases, the agent's dashboard GUI includes a list of cases for which the agent is responsible, and optionally, a list of cases for which the agent's team is responsible. The dashboard GUI can also include a listing of all active cases associated with a particular account or sub-account, contract, customer, customer department, customer team, and/or customer contact. The dashboard GUI can also include a list of active cases within the CSM system. This option would typically be reserved for a supervisory agent.

When an agent selects a case from the dashboard GUI, a new screen or window is displayed showing additional details of the selected case. The types of details displayed will depend upon the agent's duties and responsibilities, as configured by the administrator.

For example, the agent will typically be provided with at least some of the case qualification information, plus any textual description associated with the service request, any attached files, and the history of the case. The agent will also be provided with links to any tools or resources that are available to the agent. The agent is optionally provided with a choice of creating a parent or child case and associating it with the present case. The agent might not, however, have a need to see one or more aspects of the customer context information, such as contract or account information. Thus, this information is typically not presented to such an agent.

Where the agent is tasked with opening new cases in response to customer service requests, the agent's dashboard GUI will typically include a selectable feature for opening a new case template. The new case template will typically include fields for customer context information (e.g., customer/contact identification information, contract/account information, and any SLA information), and case qualification information. If the agent is tasked solely with opening new cases, the selectable new case creation feature may be the only option available to the agent.

Where the agent is tasked with supervising other agents (i.e., a supervisory agent), the agent's dashboard GUI can be configured to display cases for which the agent has supervisory authority. Alternatively, or additionally, agent's dashboard GUI can be configured to display names of agents or teams for which the agent has supervisory authority. The supervisory agent can select a case, wherein the agent is presented with details for the selected case. The information can include case history and/or statistics information, such as how long the case has been pending.

A supervisory agent's dashboard GUI can also include a list of cases that have been escalated to the supervisory agent.

b) Self-Service Portals

Self service portals are typically GUI-based portals, such as internet portals or other computer based terminals. Self-service portals can be provided for use by customers, non-customers, and/or remote agents.

Self-service portals can be configured to allow users with as much, or as little access to the CSM system as desired. For example, self service portals can be configured to allow users to create new cases, view existing cases, view or modify customer context information, and/or view or generate reports and statistics.

Self-service portals can provide direct links to the CSM system, or indirect links. Direct links allow external users to, for example, create new cases or generate reports without agent interaction. Indirect links require some agent action before an externally requested action is performed. For example, an external request to create a new case can be reviewed and/or modified by an agent before a new case is created in the CSM system.

Example self-service portal operations are described below in the context of creating new cases. Based on the discussion herein, one skilled in the relevant art will understand how to utilize self-service portals for other tasks.

c) Partner Interfaces

Partner interfaces allow the CSM organization to seek assistance from partners in resolving cases. When such assistance is requested, cases within the CSM system can be flagged with an indication that it is waiting for a response from the partner, or can be transferred to a partner queue.

Partner interfaces can be human-to-human, CSM system-to-human, or CSM system-to-CSM system. Partner interfaces can include internet portals, telephone links (including voice-to-voice, touch-tone activated systems, and voice recognition systems), email systems, text messaging systems, facsimile, and conventional mail.

In an embodiment, when the CSM organization requires partner assistance for a case, the case is “transferred” from the CSM organization to a partner. Cases transferred to a partner generally do not include all of the case information in the CSM system. Instead, the information is typically limited on a need-to-know basis. For example, original customer context information can be replaced with CSM organization context information.

When a case is transferred to a partner, a new case is typically created in the partner's organization. Such a new case can be created in a CSM system as described herein, or in any other suitable way.

Where an electronic link is used, relevant information from the transferred case can be parsed and populated into the partner's new case. This can be performed automatically, or with human assistance or oversight within the partner organization.

The CSM system can be configured to allow partners to view or generate reports or statistics associated with certain cases of interest to the partner. For example, where the partner is a manufacturer or service provider, and the CSM organization receives customer service requests from customers of the partner, the partner is likely to be interested in statistics associated with corresponding cases handled by the CSM organization.

In some situations, users within a partner organization can be assigned as agents with limited access rights. In this situation, cases that are appropriate for the partner organization can be directly assigned to the partner “agent.” A separate “partner queue” can be used to hold such cases.

The CSM system can be configured to share knowledge from the knowledge base 102 (FIG. 1) that relates to products or services for which assistance might be sought.

Where a partner also utilizes a CSM system as described herein, the partner interface can include a direct link between the two CSM systems, with appropriate firewalls to protect confidential information.

d) Additional Interface Modes

The CSM system is optionally configurable to provide other modes of access such as, for example, and without limitation, conventional telephony (i.e., speech-to-speech), automated telephony (e.g., touch tone or voice recognition), text-to-speech and/or speech-to-text systems, electronic mail, instant messaging, text messaging, short messaging (SMS), facsimile, and/or conventional mail.

2. Case Creation

Cases are generally created by agents of the CSM organization. The CSM system is optionally configurable to allow non-agents, such as existing customers or potential customers, to create cases through electronic mail, and/or self help portals. The case creation process can be partially automated or fully automated. Example methods for case creation are provided below. The invention is not, however, limited to the examples. Based on the description herein, one skilled in the relevant art(s) will understand how to implement case creation through other methods, which other methods are within the spirit and scope of the invention.

a) Agent Case Creation

When an agent is authorized to create new cases, the agent's dashboard GUI will include a feature that allows the agent to create a new case. The feature can be in the form of a pull-own menu, a side bar, or a tab. When an agent selects to create a new case, the agent is presented with a new case template form. As described above, the new case template form optionally includes one or more sets of scripted questions. In an embodiment, the scripted questions employ dependencies so that subsequent questions are selected based on prior answers. The scripted questions can be directed to customer context information and/or case qualification information.

In creating new cases, agents can interface with a customer through one or more of a variety of interfaces such as, for example, the internet, conventional telephony (i.e., speech-to-speech), automated telephony (e.g., touch tone or voice recognition), text-to-speech and/or speech-to-text systems, electronic mail, instant messaging, text messaging, short messaging (SMS), facsimile, and/or conventional mail.

The agent inputs available information into the new case template. Scripted questions can be used to walk the agent thorough the case creation process. The CSM system can be configured by the administrator to automatically fill in one or more fields based on dependencies, and/or to provide subsequent scripted questions based on dependencies associated with answers to previous questions.

The new case template can include a free text field allowing the agent to input additional information related to the customer service request. The new case template can also be configured to allow the agent to attach files, such as audio, visual, graphical, and/or text files.

In an embodiment, case creation is performed by one or more dedicated case creation agents, while case resolution is performed by one or more dedicated case resolution agents. Dedicated case creation agents require little, if any, knowledge of the services or products for which customer service is provided by the CSM organization. Instead, the case creation template and optional scripted questions will guide the case creation agents through the process, with possible assistance from the knowledge base. In an embodiment, the CSM case creation agents are geographically distributed from other agents. The invention is not, however, limited to these examples.

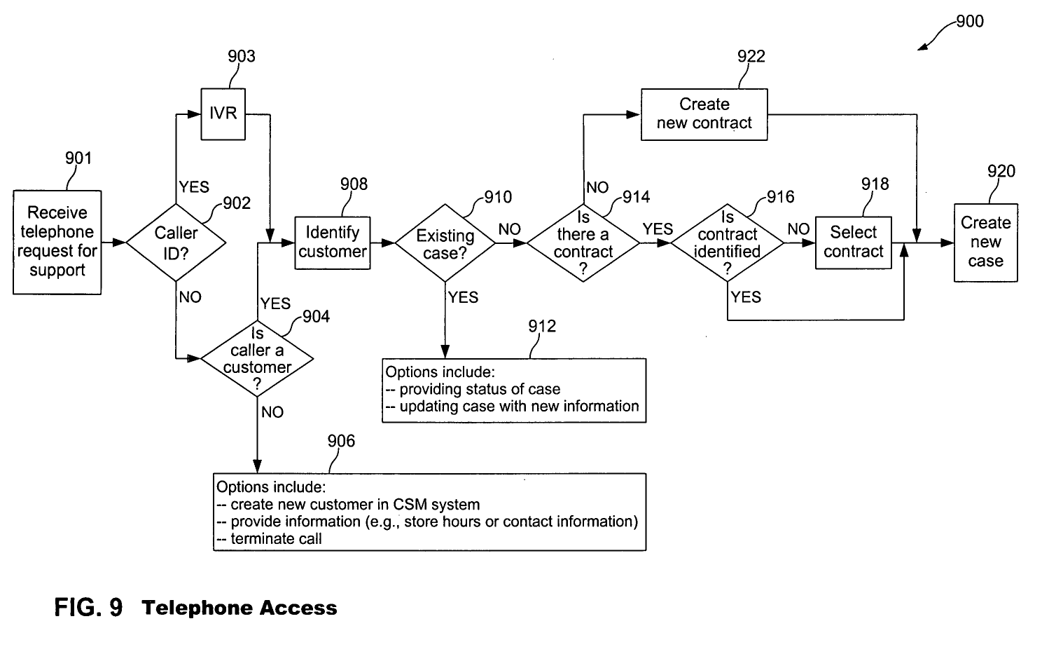

FIG. 9 is process flowchart 900 illustrating an example case creation process. The process begins with step 901, receiving a request for support. The request can be received via any method. For exemplary purposes, the process is described for where the request is received by telephone.

In step 902, a determination is made as to whether an electronic identification associated with the telephone call is also associated with an existing customer. If so, processing proceeds to step 903, where a customer is identified from the electronic identification. Step 903 can include, for example, and without limitation, an integrated voice response system and/or other automated system to interface with the caller to confirm the customer identity. Steps 902 and 903 are optional.

In an embodiment, dedicated telephone numbers are assigned according to some aspect of customer context (e.g., customer, subsidiary, department, contact, account, or contract), or product/service qualification. This provides immediate identification of the corresponding context information, which will reduce the time needed to create a case.

The steps herein can be performed manually or automatically, that is, without agent intervention. For example, the CSM system can include an automated telephony system that presents selectable options to the caller. The automated telephony system can include a voice recognition system that allows callers to respond by voice rather than by touch tone.

In step 904, a determination is made as to whether the caller is an existing customer. If not, processing proceeds to step 906. Step 906 can include a variety of options, such as, for example, creating a new customer identification in the CSM system, providing information to the caller (e.g., store hours, directions, or contact information), or terminating the call. If the caller is an existing customer, processing proceeds to step 908.

In step 908, the customer is identified to the CSM system. Customer identification includes sufficient customer context information to identify the customer. Where dependencies are employed, the customer can be identified from partial customer context information. Three such examples are provided below. The invention is not, however, limited to these examples.

In a first example, an account is identified to the CSM system, from which the CSM system identifies any associated contracts. Where there are multiple contracts associated with the account, the CSM system can provide a list of the contracts to select from.

In a second example, a contract is identified to the CSM system, from which the CSM system identifies the customer.

In a third example of customer identification, a search is performed on other information provided by the caller, such as a multi-criteria search. The search can be based on any information, or combination of information, stored in the database 206. Where the search results in multiple customer identifications, the CSM system can provide the list of customers to select from.

In step 910, a determination is made as to whether the call relates to an existing case or a new issue. If the call relates to an existing case, processing proceeds to step 912. In step 912, the caller can be provided with information related to the case, or the case can be updated with new information. Step 912 can be performed automatically by the CSM system, manually, or partially automatic.

If the call relates to a new issue, processing proceeds to steps 914 through 918, where a contract is identified. Contract identification can be performed automatically based on prior information provided to the CSM system, or the CSM system can prompt the user for more information.

Referring back to step 914, if there is not an existing contract, processing optionally proceeds to step 922, where a new contract is created.

From steps 922 and 918, processing proceeds to step 920, where a new case is created.

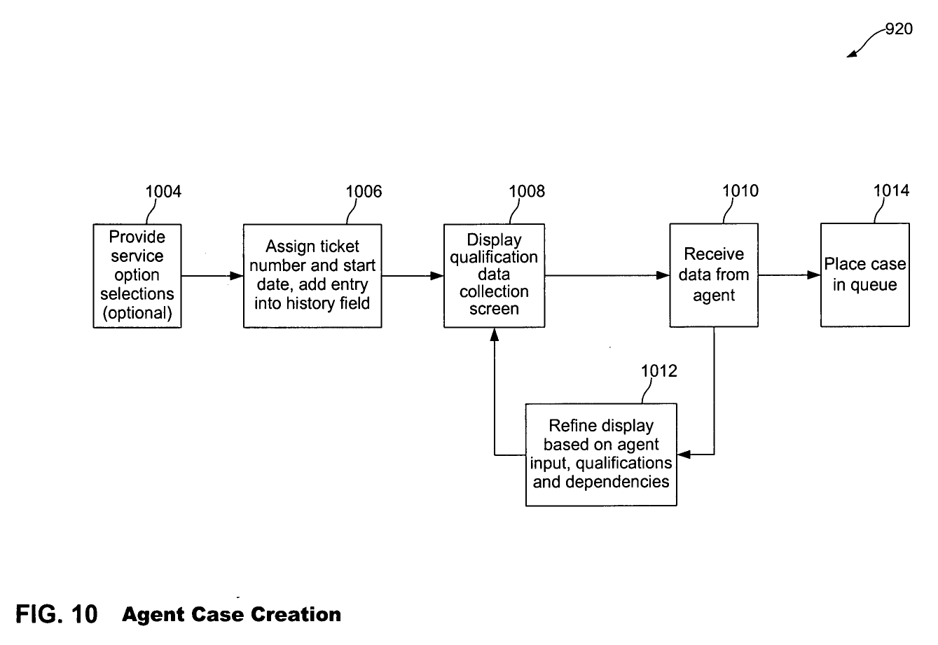

FIG. 10 is a process flowchart 1000, illustrating an example method for implementing step 920, agent case creation. The process begins at step 1004, where a service option is selected. This step is optional for where the CSM system is configured for multiple service options. Service options can include, for example, sales, marketing, technical produce/service support, product development, and research and development. Where service options are employed, they become part of the service context, in that GUIs, SLAs, and routing rules can be applied according to the selected service option.

In step 1006, the CSM system creates a new entry in the database, assigns a ticket number to the new case, assigns a start date to the new case, and creates a first entry in the history field of the new case.

In step 1008, the CSM system displays a qualification data collection screen. The qualification screen can be a new window, or series of windows, or other type of display. The qualification screen prompts the agent to collect qualification information from the caller. The content, format, and types of qualification information sought by the CSM system is context specific, in that it depends upon context information, such as user context, team context, tool context, and/or service context.

In step 1010, the CSM system receives qualification information from the agent. As the agent provides qualification information, step 1012 updates the qualification screen in step 1008. The updates can include, for example, displaying data input by the agent, and displaying additional qualification questions or fields to be completed by the agent. Step 1012 optionally utilizes dependencies to reduce the number of options presented to the agent.

In step 1014, the new case is placed in a queue for routing and resolution. In an embodiment, the CSM system utilizes a single queue for all cases. Alternatively, multiple queues are utilized.

b) Electronic Mail Case Creation

Cases can be created by electronic mail (“email”) or other electronic text systems. This can be fully automated, without agent input, manual, or partially automated.

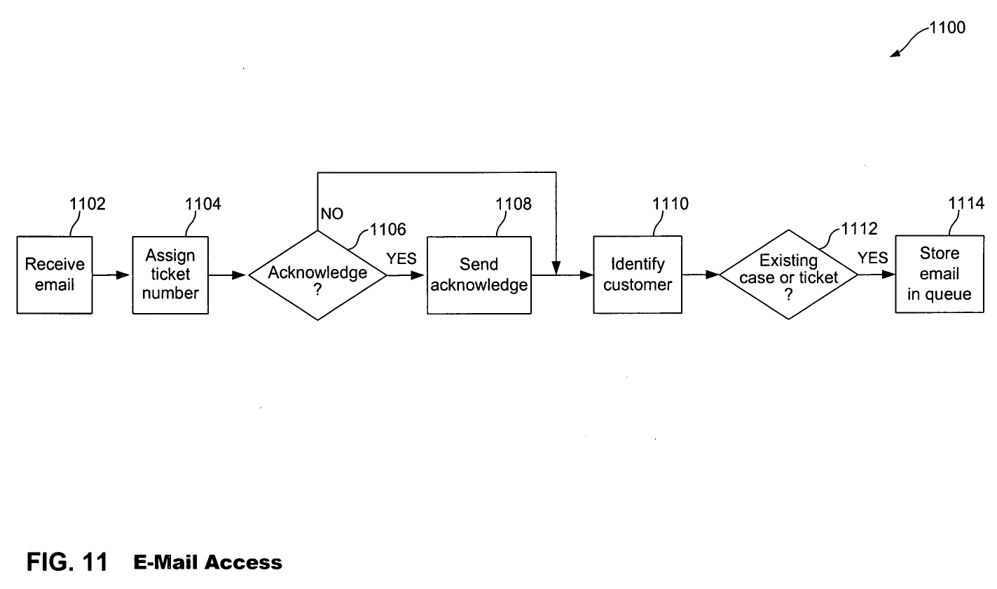

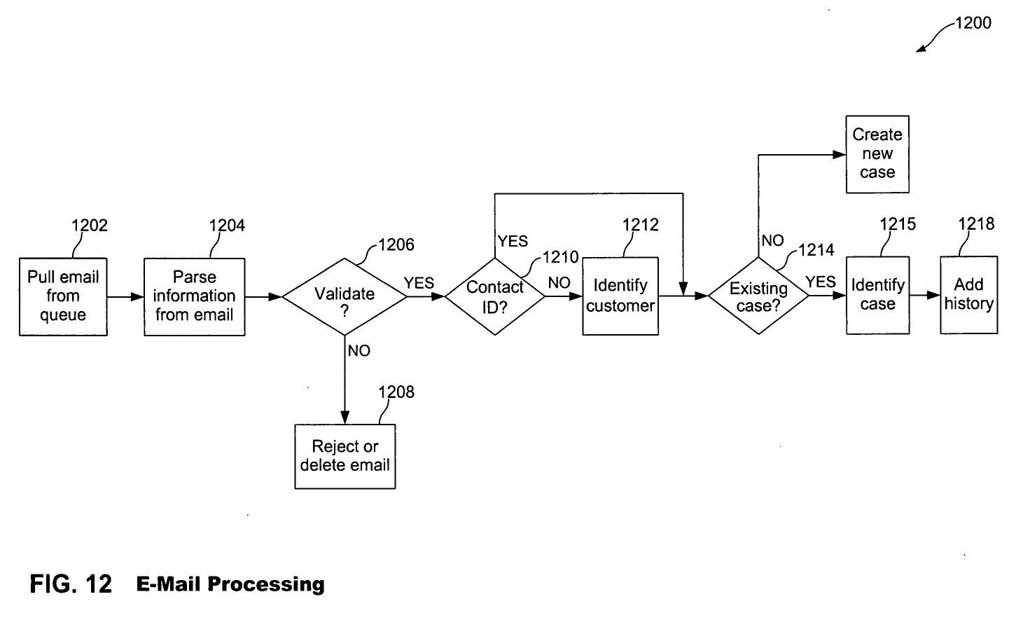

FIG. 11 is a process flowchart 1100, illustrating an example method of providing email access to the CSM system. FIG. 11 is described immediately below. FIG. 12 is a process flowchart 1200, illustrating an example method of case creation from processed emails. FIG. 12 is described further below.

In FIG. 11, the process begins at step 1102, where an email is received by the CSM system. In an embodiment, the email is pre-formatted to allow for automated parsing of relevant information from the email message. For example, where a the CSM organization hosts a web site, the web site can include a customer service link that brings up a pre-formatted email window or screen, including data entry fields to be filled out by the user. The email is pre-addressed to the CSM organization. Alternatively, the web site can be hosted by a product or service provider, where customers of the product or service provider go for customer service. In such a case, the email link is still pre-addressed to the CSM provider.

In step 1104, the CSM system assigns a ticket number is assigned to the email. This allows for tracking of the email and any subsequent case created as a result of the email.

In step 1106, a determination is made whether to send an acknowledgement. In an embodiment, all emails are acknowledged. Alternatively, the address from which an email was received is used to determine whether to acknowledge the email. Alternatively, the determination of step 1106 is made later, based upon customer identification.

In step 1108, an acknowledgement is sent. The acknowledgement will typically include the ticket number. The acknowledgement is typically sent to the sending email address. The CSM system can be configured to also send a copy of the acknowledgment to another address, with or without a copy of the contents of the original email.

In step 110, the customer is identified. The customer can be identified from the sending email address, or by parsing a customer identification from the email itself.

In step 1112, a determination is made as to whether the email relates to an existing case or a potential new case. This can be performed by examining the email for a previously assigned ticket number. If the email is not related to an existing case, it is placed in a queue for subsequent processing. The queue can be a dedicated queue for emails.

If the email relates to an existing case, several options are available. The case can be annotated or otherwise flagged and placed in the same queue as other email, or placed in a separate queue. Alternatively, the email can be attached to the case to which it pertains. The history section of the case can optionally be annotated with information from the email or with an indication that the email was received.

In FIG. 12, new cases are created from the emails in the email queue. Processing begins at step 1202, where an email is distributed (i.e., pulled or pushed) from the email queue. The email can be automatically pushed by the CSM system, or pulled by an agent.

In an embodiment, the CSM system is configured to receive emails at multiple email addresses. The email addresses can be assigned to different contexts, which can be useful for automated routing.

In step 1204, information is parsed from the email. The information can relate to customer context and/or product/service qualifications. Step 1204 can be performed manually by an agent or automatically by the CSM system.

In step 1206, a determination is made as to whether the email is a request for customer service. If it is not, (e.g., spam), the email is rejected or deleted in step 1208. Otherwise, processing proceeds to step 1210. Step 1206 can be performed manually by an agent (e.g., by clicking a “verified” tab on agent's dashboard GUI), automatically by the CSM system, or a combination thereof.

In step 1210, a determination is made as to whether contact or other customer identification is known. The contact or customer identification may have already been identified earlier in the process, or can be identified from the email itself, in which case processing proceeds to step 1214. Otherwise, processing proceeds to step 1212.

In step 1212, further steps are taken to identify the customer. Step 1212 can be an automated process whereby the database is searched for customer information associated with some aspect of the email, such as the sending email address or contact identification. Alternatively, step 1212 can be performed manually partially automatically. For example, the CSM system can search and provide a list of search results for the agent to select from.

In step 1214, a determination is made as to whether the email is associated with an existing case or a new issue. Where step 1112 was already performed, step 1214 may simply require examining the results of step 1112. Step 1214 can be performed automatically by the CSM system, manually by an agent, or a combination thereof.

Where the email pertains to a new issue, processing proceeds to step 1212, where a new case is created. The case can be created, for example, as described above with respect to FIG. 10.

Where the email pertains to an existing case, processing proceeds to step 1215, where the existing case is identified. This can be performed by examining the ticket number in the email, which can be automated or manual. Alternatively, the agent can search the database based on a customer identification, contract, or multi-criteria search as described above with respect to step 910 in FIG. 9.

When the case is identified, processing proceeds to step 1218, where the history is updated to note receipt of the email. In addition, the case can be updated with substantive information from the email, such as new contact information, new qualification information, free text, and/or attached files.

c) Self Service Portal Access and Case Creation

Self service portals can be used to open new cases, view and/or modify existing cases, generate reports and statistics, and/or access the knowledge base to either view or modify information, depending upon the level of access configured by the administrator.

Self service access to the CSM system can be fully automated, without agent input, or to require some level of agent input or oversight. This can be configured differently for different customers.

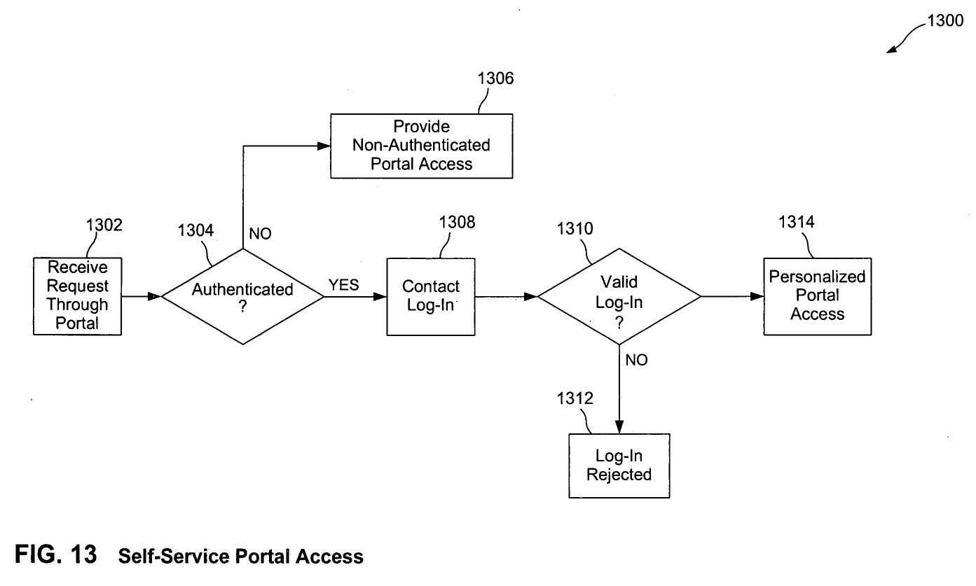

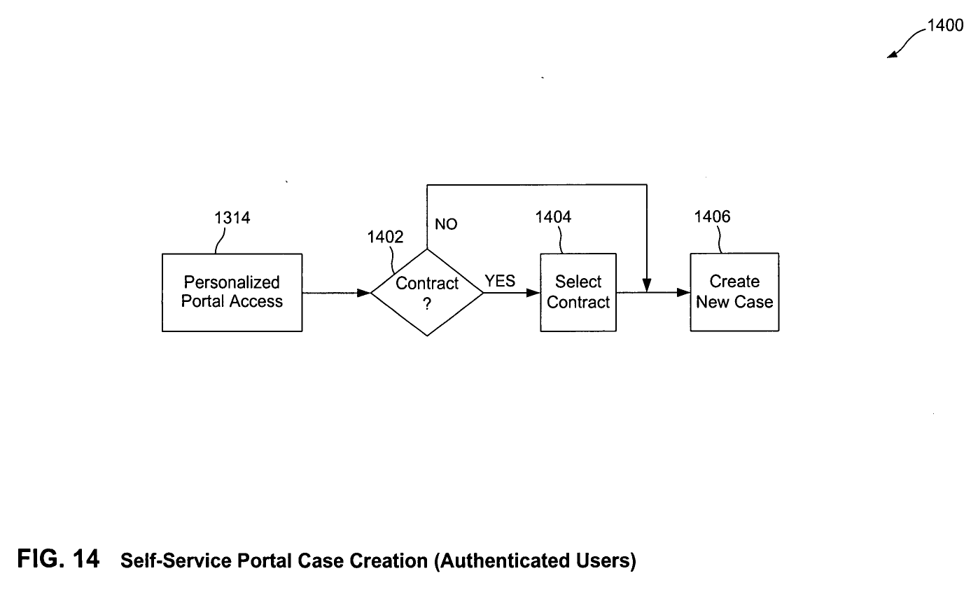

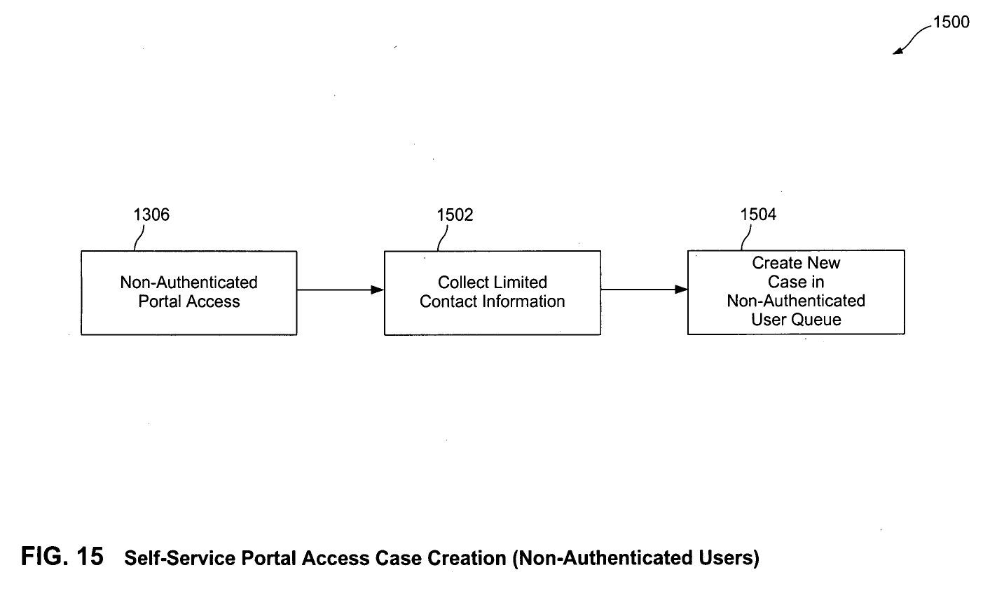

FIG. 13 is a process flowchart 1300, illustrating an example method of providing access to the CSM system through a self service portal. FIG. 13 is described immediately below. FIG. 14 is a process flowchart 1400, illustrating an example method of case creation through a self service portal for authenticated users. FIG. 15 is a process flowchart 1500, illustrating an example method of case creation through a self service portal for non-authenticated users. FIGS. 14 and 15 are described further below.

In FIG. 13, the process begins at step 1302, where a request for access is received through a portal.

In step 1304, an authentication determination is made. In an embodiment, this involves the user selecting either a registered user link or a non-registered user link. Alternatively, the CSM system makes this determination based on other user provided information.

In step 1306, non-authenticated users are presented with non-authenticated portal access. Non-authenticated portal access can be configured to provide the user with access to certain information in the knowledge base, such as store hours, locations, directions, and/or product/service availability/pricing. Non-authenticated portal access can also be configured to allow users to request customer service by creating new cases, as described below with respect to FIG. 15. This can be useful where the user purchased a product or service from a customer of the CSM organization, and where the customer contracted with CSM organization to provide customer support for the product or service.

Referring back to step 1304, where the user is authenticated, processing proceeds to step 1308, where the user provide log-in information.

In step 1310, a determination is made as to whether the log-in information is valid. If invalid, processing proceeds to step 1312, where the log-in attempt is declared a failure. The user is optionally returned to step 1308 for one or more additional log-in attempts. Upon repeated log-in failures, the user can be returned to the initial portal screen. Alternatively, the user can be presented with a screen to request resetting of a password or to register as an authenticated user. Upon successful log-in, the user is identified by the CSM system, and processing proceeds to step 1314.

In step 1314, the user is presented with a personalized portal screen that is associated with the user. The portal screen is configured for format, content, and access rights, by the administrator. The administrator can delegate certain formatting options to the user.

FIG. 14 is a process flowchart 1400, illustrating an example method of case creation through a self service portal for authenticated users. Processing begins at step 1314 from FIG. 13, from where the user selects to create a new case.

Before a new case is created, a contract needs to be identified, possibly along with an account and/or SLA. Accordingly, in steps 1402 and 1404 a contract is identified. This process can be similar to that described above with respect to steps 914, 916, 918, and 922, in FIG. 9.

Upon identification of a contract, processing proceeds to step 1406, where a new case is created in the database. Step 1406 can be implemented similar to that described above with respect to step 920 in FIG. 10.

FIG. 15 is a process flowchart 1500, illustrating an example method of case creation through a self service portal for non-authenticated users. Processing begins at step 1306 from FIG. 13, from where the user selects to create a new case.

Before a new case can be created, at least a limited amount of contact information needs to be obtained from the user to allow the CSM organization to respond to the user. Accordingly, in step 1502, contact information is obtained from the user.

In step 1504, a new case is created in the database. Step 1504 can be implemented similar to that described above with respect to step 920 in FIG. 10.

The new case can be placed in a special queue for non-authenticated users, or in any other queue according to the configuration of the CSM system.

3. Resolution

Cases are routed to agents or teams based on the context mappings configured by the administrator, as described in sections above. Cases can be pushed or pulled. Once assigned to an agent or team, resolution actions can be performed.

Resolution actions can include providing a written response or instructions within the case, sending parts or software updates, and/or attaching files to the case. These actions can be taken based on agents' knowledge, or knowledge obtained from the knowledge base, or based upon responses to cases that were transferred to partners.

Actions can also include case transfers (within the CSM system or to partners), creation of parent or child cases (with or without transfer), and closing cases.

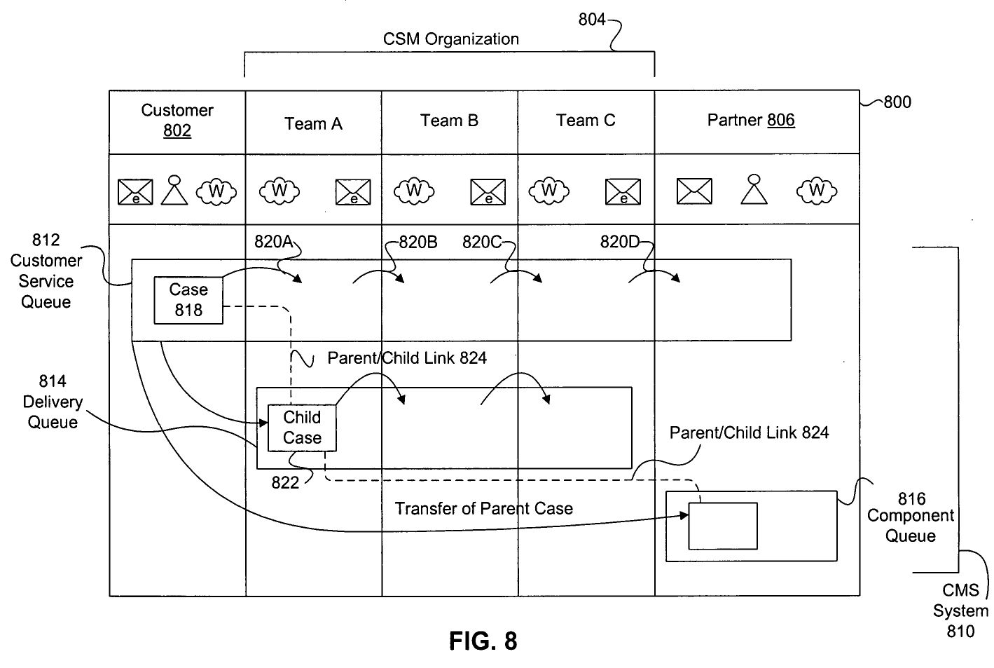

FIG. 8 is an illustration of an example case management scenario 800 for managing customer service within a CSM system 810. The scenario 800 includes a customer 802, a CSM organization 804, and a partner organization 806. The CSM organization 804 includes teams A, B, and C.

In the example of FIG. 8, the customer 802 can access the CSM system 810 via electronic mail, telephone, and the internet. Teams A, B, and C, can access the CSM system 810 via electronic email and the internet. The partner organization 806 can access the CSM system 810 via electronic mail, telephone, and the internet. The invention is not, however, limited to these examples.

Customer 802, teams A, B, and C, and partner organization 806 can each be provided with different access rights and different GUIs, including different information content and formats, to the CSM system 810.

The example CSM system 810 includes three queues, a customer service queue 812, a delivery queue 814, and a component queue 816.

In the example of FIG. 8, the customer 802 creates a case 818, by electronic mail, telephone, or through an internet self help portal, with or without agent assistance. In an embodiment, the customer 902 is an end user of a purchased product. The customer calls a telephone number or accesses a web site link identified by the product seller or manufacturer. Unbeknownst to the customer, the telephone number or web site link is associated with the CSM provider, with whom the product seller or manufacturer contracted for customer service.

In the example of FIG. 8, the case 818 is routed to team A, then sequentially transferred to team B, team C, and the partner 806, as illustrated by arrows 820. Prior to one or more of the transfers, an agent may provide resolution information to the case, by way of text and/or attached files. The agent may use the knowledge database described above, and/or one or more available tools, in providing the resolution information. Each time the case is transferred or a resolution action is performed, a history field of the case is updated to record the action.

In the example of FIG. 8, team A generates a child case 822, which is transferred to the delivery queue 814. The child case 822 can be created, for example, to schedule delivery of a package to the customer or to order a component needed for case resolution. The child case 822 can be placed in the delivery queue 814 upon command of team A, or automatically based upon case qualification information provided by team A. Alternatively; the child case can remain in the customer service queue or can be placed in any other suitable queue.

The child case 822 is linked to the parent case 818 as illustrated by parent/child link 824. As a result of the link 824, the parent case 818 remains associated with the child 822. During resolution of the child case 822, agents can populate the child case 822 with additional information and/or linked files related to resolution of the child case. Upon resolution of the child case, case management rules will determine whether the parent case 818 is automatically closed, and whether any notifications are sent, and to whom.

Instead of transferring the parent case to teams B, C, and the partner, the parent case 818 can transferred to the component queue 816. This can occur where the resolution of the parent case 818 requires assistance from the partner 806.

The example of FIG. 8 illustrates some of the case management functions for which a CSM system is configurable. The invention is not, however, limited to the example of FIG. 8. Based on the teachings herein, one skilled in the relevant art(s) will understand that a CSM system can be configured for other functions.

a) Field Service and Geo-Localization

Cases can be routed to, or transferred to field service agents for on-site support, as indicated by block 104 in FIG. 1. When the CSM system is configured for geo-localization field service support, cases are transferred to field service agents according to their proximity to the site. The location of field service agents can be determined with GPS tracking systems and/or according to their assigned location. The CSM system can be configured to automatically assign or push cases to the nearest available field service agent, or a transferring agent can to select from a list of available field service agents.

### C. Reporting and Statistics

The report/statistics generator 212 (FIG. 2) is pre-encoded to be configurable by the administrator. The report/statistics generator 212 can be configured to provide any information that is stored within the database 206, in a wide range of formats. The report/statistics generator 212 can also be configured to compile statistical data from the information stored within the database 206, and to provide the statistical data in a wide range of formats. For example, and without limitation, the report/statistics generator 212 can be configured to generate reports or statistics based on one or more of the following:

number of cases opened by an agent or team over a period of time;

number of cases resolved by an agent or team over a period of time;

average time to resolution for an agent or team;

number of cases created, open, or resolved, for a customer, division, department, contact, account, or sub-account, over a period of time; and

comparison of statistics between agents or teams.

The statistics and reports can be further based on selected context information.

The report/statistics generator 212 can be configured to provide different types of information and statistics, and different levels of detail, to different users, based on the users' roles and need to know. For example, referring to FIG. 7, a contact associated with a department 704 may be given access to reports and statistics associated only with the department 704. A contact associated with a store 702 may be given access to reports and statistics associated with the store and all of its associated departments.

CSM reporting and statistics can be used to monitor and improve work flow and efficiency of the CSM organization. Work flow and efficiency changes can be implemented by reconfiguring the CSM system based an analysis of the reports and statistics.

CSM reporting and statistics can also be used to monitor the cost of providing customer service for a given customer, customer division, department, contact, account or sub-account. CSM reporting and statistics can also be used to monitor the cost of providing customer service for a given product or service.

The report/statistics generator 212 (FIG. 2) also reports case resolution to customers. Resolution reporting can be provided by a variety of channels including, for example, and without limitation, the internet, conventional telephony (i.e., speech-to-speech), automated telephony (e.g., touch tone or voice recognition), text-to-speech and/or speech-to-text systems, electronic mail, instant messaging, text messaging, short messaging (SMS), facsimile, and/or conventional mail.

### V. EXAMPLE COMPUTER IMPLEMENTATION

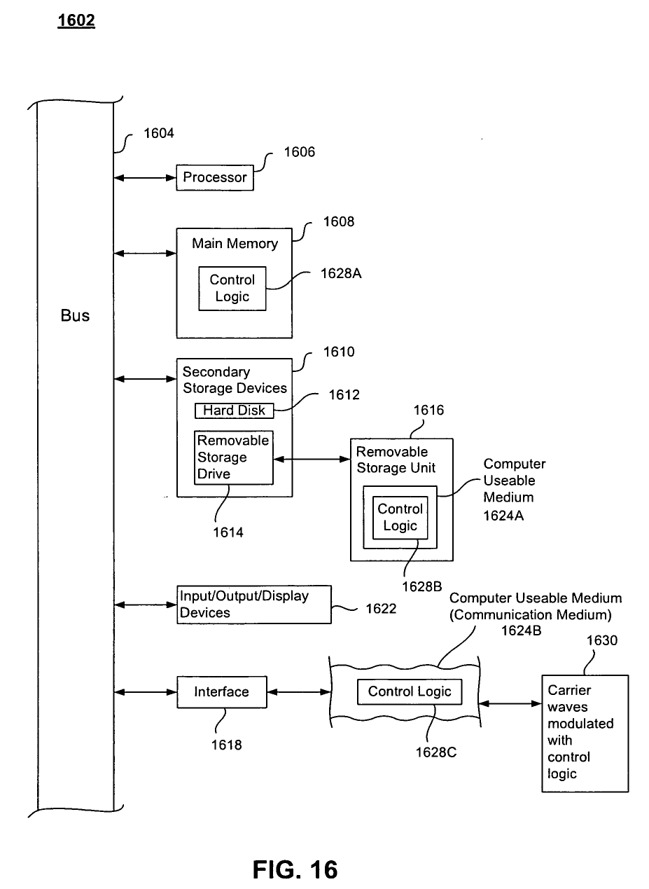

The functionality of the invention as described herein may be achieved using well known computers, such as computer 802 shown in FIG. 16.

The computer 1602 can be any commercially available and well known computer capable of performing the functions described herein, such as computers available from International Business Machines, Apple, Sun, HP, Dell, Compaq, Digital, Cray, etc.

The computer 1602 includes one or more processors (also called central processing units, or CPUs), such as a processor 1606. The processor 1606 is connected to a communication bus 1604.

The computer 1602 also includes a main or primary memory 1608, such as random access memory (RAM). The primary memory 1608 has stored therein control logic 1628A (computer software), and data.

The computer 1602 also includes one or more secondary storage devices 1610. The secondary storage devices 1610 include, for example, a hard disk drive 1612 and/or a removable storage device or drive 1614, as well as other types of storage devices, such as memory cards and memory sticks. The removable storage drive 1614 represents a floppy disk drive, a magnetic tape drive, a compact disk drive, an optical storage device, tape backup, etc.

The removable storage drive 1614 interacts with a removable storage unit 1616. The removable storage unit 1616 includes a computer useable or readable storage medium 1624 having stored therein computer software 1628B (control logic) and/or data. Removable storage unit 1616 represents a floppy disk, magnetic tape, compact disk, DVD, optical storage disk, or any other computer data storage device. The removable storage drive 1614 reads from and/or writes to the removable storage unit 1616 in a well known manner.

The computer 1602 also includes input/output/display devices 1622, such as monitors, keyboards, pointing devices, etc.

The computer 1602 further includes a communication or network interface 1618. The network interface 1618 enables the computer 1602 to communicate with remote devices. For example, the network interface 1618 allows the computer 1602 to communicate over communication networks or mediums 1624B (representing a form of a computer useable or readable medium), such as LANs, WANs, the Internet, etc. The network interface 1618 may interface with remote sites or networks via wired or wireless connections.

Control logic 1628C may be transmitted to and from the computer 1602 via the communication medium 1624B. More particularly, the computer 1602 may receive and transmit carrier waves (electromagnetic signals) modulated with control logic 1630 via the communication medium 1624B.

Any apparatus or manufacture comprising a computer useable or readable medium having control logic (software) stored therein is referred to herein as a computer program product or program storage device. This includes, but is not limited to, the computer 1602, the main memory 1608, the secondary storage devices 1610, the removable storage unit 1616 and the carrier waves modulated with control logic 1630. Such computer program products, having control logic stored therein that, when executed by one or more data processing devices, cause such data processing devices to operate as described herein, represent embodiments of the invention.

The invention can work with software, hardware, and/or operating system implementations other than those described herein. Any software, hardware, and operating system implementations suitable for performing the functions described herein can be used.

### VI. CONCLUSION

The present invention has been described above with the aid of functional building blocks illustrating the performance of functions and relationships thereof. At least some of the boundaries of these functional building blocks have been arbitrarily defined herein for the convenience of the description. Alternate boundaries can be defined so long as the specified functions and relationships thereof are appropriately performed. Any such alternate boundaries are thus within the scope and spirit of the claimed invention.

It is to be appreciated that the Detailed Description section, and not the Summary and Abstract sections, is intended to be used to interpret the claims. The Summary and Abstract sections can set forth one or more, but not all exemplary embodiments of the present invention as contemplated by the inventor(s), and thus, are not intended to limit the present invention and the appended claims in any way.

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A customer service management (“CSM”) system, comprising:
a communication module configured to interface between the system and a customer to receive a customer service request;
a case management module configured to generate a case based on said customer service request and to route said case to an agent, team, and/or partner based;
a Graphical User Interface (GUI) module configured to generate a GUI for said agent, team, and/or partner, wherein said GUI presents said agent, team, and/or partner with information, tools, and resources adapted to said agent, team, and/or partner to resolve said case.

2. The system according to claim 1, wherein said communication module includes an email interface, a phone interface, and/or a web interface that supports live chat or a self-service portal.

3. The system according to claim 1, further comprising:
a rules engine configurable by a system administrator to specify rules for case creation, case transfer, case routing, case closing, case escalation, collaboration, and tools access.

4. The system according to claim 1, further comprising:
a knowledge engine accessible by said customer or by said agent, team, and/or partner, said knowledge engine containing information related to product or services for which customer service is being provided.

5. The system according to claim 4, wherein said knowledge engine includes keyword, free text, and natural language search capabilities.

6. The system according to claim 4, wherein said knowledge engine includes capabilities to define its knowledge base by service context.

7. A customer service management (“CSM”) system, comprising:
administrator selectable rules and configuration parameters;
a knowledge database that contains information related to case resolution;
computer readable instructions that cause a computer system, on which the CSM system is installed, to generate an administrator graphical user interface (“GUI”) that prompts an administrator to map the rules and configuration parameters to one or more of customer context information, case qualifications, service context information, knowledge base context, and/or tools context information, to thereby determine access rights, information display content, information display formats, and case creation and management rules;
pre-encoded computer readable instructions that cause the computer system to configure a database with the rules and configuration parameters as mapped by the administrator;
computer readable instructions that cause the computer system to generate dashboard GUIs that allow agents to interface with the database in accordance with the access rights, information display content, information display formats, and case creation and management rules, and
computer readable instructions that cause the computer system to create cases in the database, and to route, transfer, escalate and close the cases in response to agent commands, and in accordance with the rules.

8. A method for customer service management, comprising:
receiving a customer service request;
generating a case based on said customer service request, wherein said case characterizes said customer service request based on one or more of a customer context, a service context, a request context, and a knowledge context;
routing said case to an appropriate agent, team, and/or partner based on routing rules; and
dynamically generating a dashboard Graphics User Interface (GUI) when said case is accessed by said agent, team, and/or partner, wherein said dashboard GUI is configured to present said agent, team, and/or partner with information, tools, and resources adapted to said agent, team, and/or partner to resolve said case.

9. The method according to claim 8, wherein receiving a customer service request includes receiving said customer service request via email, phone, or web interface supporting a live chat or a self-service portal.

10. The method according to claim 8, wherein said customer context includes information related to one or more of a customer account profile, a customer contact profile, a service contract, a service level agreement (“SLA”), and a customer history.

11. The method according to claim 8, wherein said service context includes information related to one or more of the severity of the requested service, time availability of the requested service, and business rules associated with the requested service.

12. The method according to claim 8, wherein said request context includes information related to one or more qualifiers of said customer service request including question type, state, severity, and history.

13. The method according to claim 8, wherein said knowledge context includes one or more of related customer service experience, related knowledge, and other external contextual information.

14. The method according to claim 8, further comprising mapping context information including customer context, service context, and/or request context to agents, teams, and/or partners.

15. The method according to claim 8, further comprising adapting routing rules according to agent, team, and/or partner work load; agent, team, and/or partner availability; and queue depth.

16. The method according to claim 8, wherein said routing rules account for geographical locations of agents, teams, and/or partners.

17. The method according to claim 8, further comprising adapting said information, tools, and resources according to duties and/or responsibilities of said agent, team, and/or partner.

18. The method according to claim 8, further comprising varying an appearance of said dashboard GUI according to one or more of said customer context, service context, and agent, team, and/or partner.

19. A method of providing customer service management with a computer-implemented customer service management (“CSM”) system, comprising:
presenting an administrator with an administrator graphical user interface (“GUI”);
receiving customer context information from the administrator, including an identification of one or more customers and any associated contracts, accounts, sub-accounts, contacts, and service level agreements (“SLAs”);
receiving service context information from the administrator, identifying one or more products and/or services to be managed by the CSM system;
receiving team context information from the administrator, regarding the CSM organization, including an identification or definition of one or more of teams and/or agents, their areas of expertise, their availability schedules, and any SLAs;
receiving information from the administrator, mapping rules to be applied by the CSM system for case creation, case routing, case transfer, case escalation, case closing, knowledge database access, and tools access, to combinations of the customer context information and the service context information;
receiving information from the administrator, mapping display formats, content, tools access, and knowledge base access, to the teams and agents based upon the teams' and agents' roles and responsibilities,
receiving information from the administrator, mapping interface rules, display formats, content, and tools access, to the customers and partners to limit the information and tools to be available to the customers' and partners' on a need to know basis;
configuring a database with the information received from the administrator using pre-encoded computer instructions; and
presenting agents with dashboard GUIs having information content, tools access, and knowledge base access, limited to that which is reasonably necessary to the agents' and teams' roles and responsibilities.

20. The method according to claim 19, further comprising:
receiving a request from an agent, through the dashboard GUI, to create a case;
creating a new case in the database;
receiving initial information from the agent regarding customer context information and/or product/service qualification information;
populating the case with the initial information;
further populating the case with additional information based on dependency rules; and
routing the case to an assigned agent or team according to the routing rules.

21. The method according to claim 20, wherein the further populating of the case is performed in less than three seconds.

22. The method according to claim 20, further comprising presenting the case to the assigned agent through the dashboard GUI and providing the agent with the following options:
accessing one or more tools;
updating the case with resolution information;
transferring the case; and
closing the case.

23. The method according to claim 22, further comprising providing the agent with an option to input textual information and to attach files to the case.

24. The method according to claim 22, further comprising providing the agent with an option to transfer the case to another agent, team, queue, or to a partner.

25. The method according to claim 22, further comprising notifying a customer when the case is closed.

26. The method according to claim 22, further comprising escalating the case when a time limit is near expiration.

27. The method according to claim 22, further comprising providing the agent with an option to create a parent or child case associated with the first case, and providing the agent with an option to transfer any of the cases.

28. The method according to claim 22, further comprising providing the agent with an option to transfer the case to a field service agent.

29. The method according to claim 28, wherein the field service agent is selected by the CSM system based on the geographical location of the field service agent.

30. The method according to claim 28, wherein the field service agent is selected by the CSM system based on an automatic geographical position determining system located proximate to the field service agent.

31. The method according to claim 19, further comprising providing the customers with access to the CSM system through a GUI portal.

32. The method according to claim 31, further comprising providing the customers with an option of opening new cases through the GUI portal.

33. The method according to claim 31, further comprising providing the GUI portal based on SML industry standards.

34. The method according to claim 19, further comprising applying dynamic rules to cases.

35. The method according to claim 34, further comprising applying dynamic routing rules to cases that take into account current case loading statistics.

36. The method according to claim 19, wherein said service context information further includes service timetable, severity, qualifications, data to prompt and collect, and associated business rules.

37. A computer program product comprising a computer useable medium having computer program logic recorded thereon for enabling a processor to run a customer service management system, the computer program logic comprising:
means for enabling the processor to receive a customer service request;
means for enabling the processor to generate a case based on said customer service request;
means for enabling the processor to route said case to an appropriate agent, team, and/or partner based on routing rules;
means for enabling the processor to dynamically generate a dashboard Graphical User Interface (GUI) when said case is accessed by said agent, team, and/or partner, wherein said dashboard GUI is configured to present said agent, team, and/or partner with information, tools, and resources adapted to said agent, team, and/or partner to optimally resolve said case.
